(19) United States
(12) Patent Application Publication
(10) Pub. No.: US 2016/0273467 A1
(43) Pub. Date: Sep. 22, 2016

(54) ENGINE WORKING MACHINE

(71) Applicant: HITACHI KOKI CO., LTD., Tokyo (JP)

(72) Inventors: Yoshikazu KAWANO, Hitachinaka-shi (JP); Junichi KAMIMURA, Hitachinaka-shi (JP); Takuhiro MURAKAMI, Hitachinaka-shi (JP)

(21) Appl. No.: 14/442,379

(22) PCT Filed: Nov. 13, 2013
(86) PCT No.: PCT/JP2013/006684

§ 371 Date: May 12, 2015

(30) Foreign Application Priority Data
Nov. 14, 2012 (JP) 2012-250223
Jan. 31, 2013 (JP) 2013-017973

(51) Int. Cl. F02D 41/06; F02B 63/02; F02M 37/00; F02D 41/30; F02M 1/16

(52) U.S. Cl. CPC F02D 41/062; F02D 41/3005; F02M 1/16; F02M 37/007; F02M 37/0076; F02B 63/02

(57) ABSTRACT

A cost of an engine working machine is suppressed, and startability of an engine is improved. In an engine working machine for driving a working tool by using an engine including: a fuel tank; a carburetor for supplying air-fuel mixture of fuel supplied from the fuel tank and air into a cylinder; a cylinder in which a piston is reciprocatable; and a crank case that holds the cylinder and forms a crank chamber, the engine working machine is provided with: an additional fuel supplying unit for supplying fuel to the engine separately from the carburetor; and a control unit for controlling an operation of the additional fuel supplying unit separately from supply of start-up fuel.

### TECHNICAL FIELD

The present invention relates to an engine working machine such as a chain saw and a brush cutter.

### BACKGROUND ART

A small-sized engine is widely used as a power source for a small-sized working machine such as brush cutters or chain saws. FIG. 17 is an outline view of a brush cutter as one example of an engine working machine 1001. As illustrated in FIG. 17, in the engine working machine 1001, for example, a small-sized two-cycle engine 1010 is mounted. The engine working machine 1001 has a driving shaft passing through a pipe-shaped main pipe 1004 although not illustrated. By rotating the driving shaft by an engine that is provided on one end of the main pipe 1004, a rotary blade 1012 provided on the other end of the main pipe 1004 is rotated. In vicinity of the rotary blade 1012, a scatter protection cover 1013 for preventing scattering of cut grass is provided. The engine working machine 1001 is carried by using a shoulder suspending belt not illustrated or others, and a handle 1008 which is operated by an operator is attached in vicinity of a longitudinal center portion of the main pipe 1004. The handle 1008 is formed in a substantially U shape. A rotation speed of the engine is controlled by the operator through a throttle lever 1007 attached to a grip portion 1009. Operation of the throttle lever 1007 is transmitted to a carburetor of the engine through a wire 1045.

The engine used for the engine working machine has a small size and a light weight and can obtain a large output, so that operation for a long time can be achieved by supplying fuel thereto. On the other hand, in the engine, it is required to reciprocate a piston through combustion of air-fuel mixture, and therefore, start-up may takes longer than an electric motor. Accordingly, Patent Literature 1 suggests an engine equipped with a manual start-up fuel supplier. In this engine, when a crank shaft is driven by a recoil-type starter, a supply button of the start-up fuel supplier is pressed, so that start-up supplemental fuel is supplied from the start-up fuel supplier to the carburetor. Further, Patent Literature 2 suggests an automatic choke mechanism in which a solenoid valve is assembled into the carburetor.

### CITATION LIST

### Patent Literature

PTL 1: Japanese Utility-Model Application Laid-Open Publication No. H06-49895

PTL 2: Japanese Patent Application Laid-Open Publication No. 2007-32500

### SUMMARY OF INVENTION

### Technical Problem

In order to improve startability of the engine, it is general, in the carburetor, to provide a manual choke mechanism or the start-up fuel supplier as described in the Patent Literature 1. When the engine is in a cold time and an outside air temperature is low, an operator who tries to start the engine up operates the choke mechanism or others for starting the engine up. In this manner, an intake air amount is reduced in the carburetor, and besides, a negative pressure is generated therein, so that fuel is forcibly drawn out of the carburetor, and the air-fuel mixture that is taken into a cylinder is thickened. However, in a conventional small-sized engine, the operator manually operates the choke or the start-up fuel supplier. It is accordingly necessary to determine when the timing to operate the choke or others is and how much the amount of operation of the choke or others is, and the determination is burden for the operator. Also, when the operation of the choke or the start-up fuel supplier is inappropriate, the start-up of the engine adversely takes for a long time in some cases. Also, since the automatic choke mechanism of Patent Literature 2 has the configuration in which the solenoid valve is assembled into the carburetor, a problem of increase in a cost of the carburetor arises.

The present invention has been made in view of the above-described background, and its preferred aim is to suppress a cost of the engine working machine and to improve the startability of the engine.

### Solution to Problem

The typical feature of the inventions disclosed in the present application will be briefly described as follows.

In an engine working machine according to one embodiment, the engine working machine drives a working tool by using an engine having: a fuel tank; a carburetor for supplying an air-fuel mixture of fuel supplied from the fuel tank and air into a cylinder; a cylinder through which piston can reciprocate; and a crank case holding the cylinder and forming a crank chamber. The engine working machine is provided with: an additional fuel supplying unit for supplying fuel to the engine separately from the carburetor; and a control unit for controlling operation of the additional fuel supplying unit separately from supply of a start-up fuel.

### Advantageous Effects of Invention

According to the present invention, since the additional fuel supplying unit is provided separately from the carburetor, the cost of the engine working machine can be suppressed, and the startability of the engine can be improved.

The above and other preferred aims and novel characteristics of the present invention will be apparent from the description of the present specification and the accompanying drawings.

### BRIEF DESCRIPTION OF DRAWINGS

FIG. 1 is a longitudinal cross-sectional view illustrating an internal structure of an engine working machine according to an example of the present invention.

FIG. 2 is a cross-sectional view taken along a line A-A in FIG. 1.

FIG. 3 is a perspective view illustrating an overall shape of an additional fuel supplying device of FIG. 2.

FIG. 4 is a side view of the additional fuel supplying device of FIG. 2.

FIG. 5 is a cross-sectional view taken along a line B-B of the additional fuel supplying device in FIG. 4.

FIG. 6 is a circuit diagram of the engine working machine according to the example of the present invention.

FIG. 7 is a graph illustrating a relation between time and a fuel flow rate in normal engine start-up according to the example of the present invention.

FIG. 8 is an operation timing chart of the additional fuel supplying device in the normal engine start-up according to the example of the present invention.

FIG. 9 is a graph illustrating a relation between time and a fuel flow rate in combination use with a maintenance mode according to the example of the present invention.

FIG. 10 is an operation timing chart of the additional fuel supplying device in the combination use with the maintenance mode according to the example of the present invention.

FIG. 11A is a flowchart illustrating a procedure for controlling start-up of the engine working machine according to the example of the present invention.

FIG. 11B is a flowchart illustrating a procedure for controlling start-up of the engine working machine according to the example of the present invention.

FIG. 12 is a longitudinal cross-sectional view illustrating an internal structure of an engine working machine according to an example of the present invention.

FIG. 13 is a cross-sectional view taken along a line A-A in FIG. 12.

FIG. 14 is a circuit diagram of the engine working machine according to the example of the present invention.

FIG. 15A is a control flowchart of a solenoid valve of the engine working machine according the example of the present invention.

FIG. 15B is a control flowchart of a solenoid valve of the engine working machine according the example of the present invention.

FIG. 16 is a diagram for explaining the fuel addition timing by using the solenoid value and a graph illustrating a relation between elapsed time and a rotation speed of the engine.

FIG. 17 is a perspective view illustrating an outline shape of one example (brush cutter) of a conventional engine working machine.

### DESCRIPTION OF EMBODIMENTS

### First Example

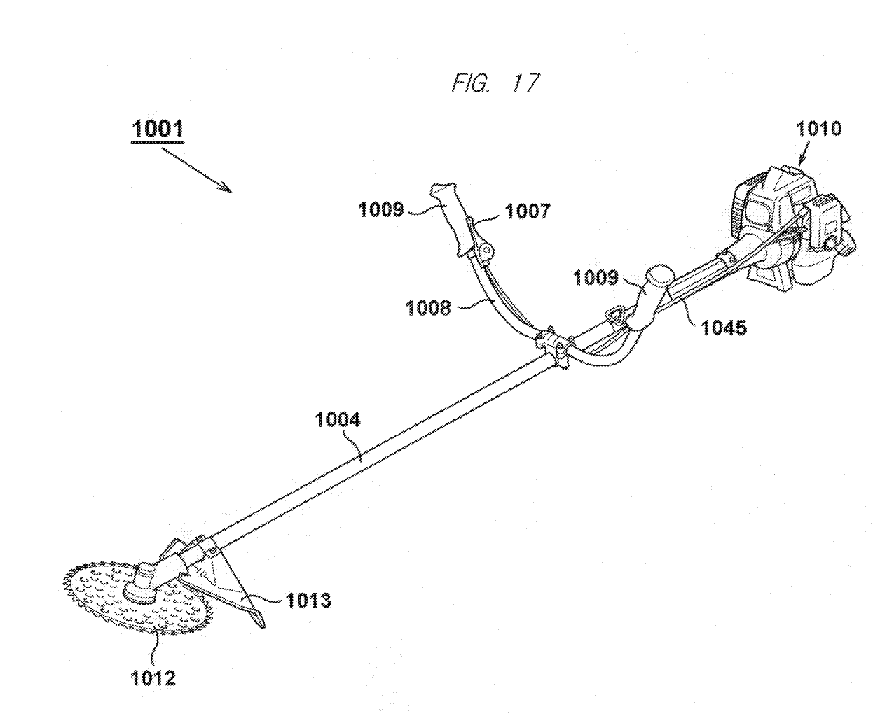

Hereinafter, a first example of the present invention will be explained based on the drawings. Note that the same components are denoted by the same reference symbols in the following drawings, and repetitive explanations thereof will be omitted. Further, the present specification will be explained so that front and back, right and left, and up and down directions are those illustrated in the drawings. While a brush cutter will be exemplified as an engine working machine 1 according to the present example, explanation of an outline shape of this brush cutter will be omitted since the outline shape thereof is the same as that as illustrated in FIG. 17.

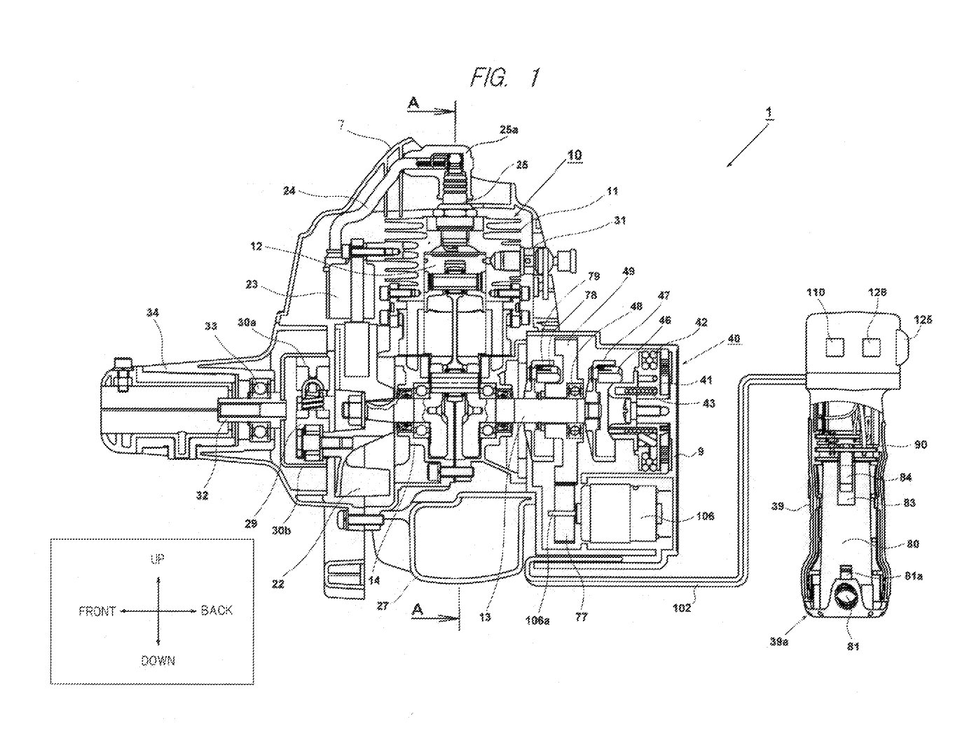

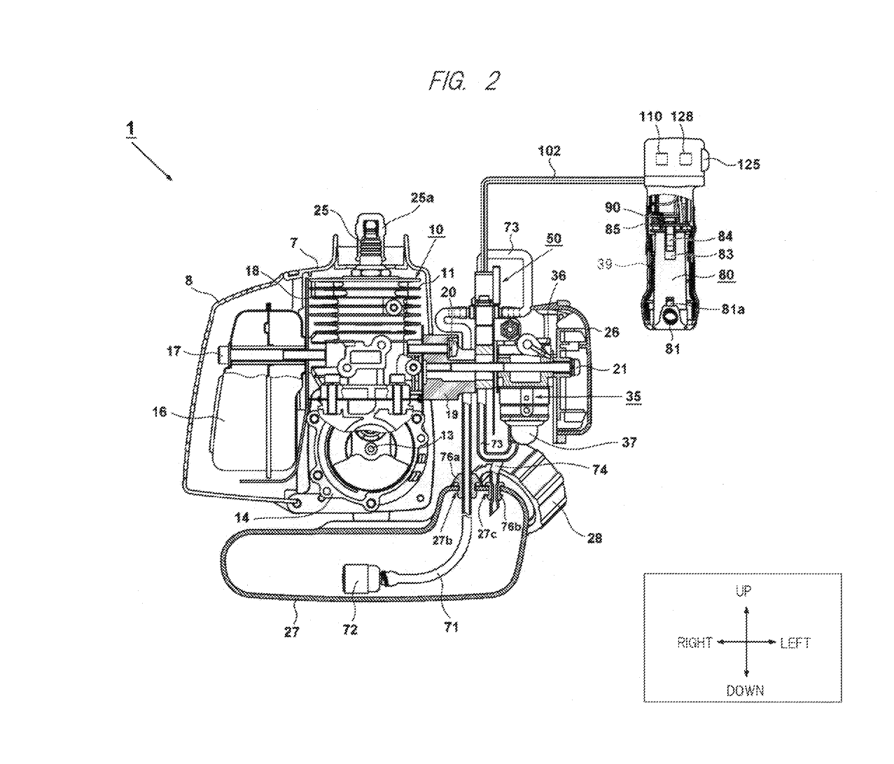

FIG. 1 is a longitudinal cross-sectional view illustrating an internal structure of the engine working machine 1 according to the present example. An engine 10 provided in the engine working machine 1 is a two-cycle small-sized engine. A crank shaft 13 provided in the engine 10 is arranged to be coaxial with a main pipe 1004 (see FIG. 17). The crank shaft 13 is housed within a crank chamber of a crank case 14 so as to be rotatable. A cylinder 11 provided in the engine 10 is arranged so as to extend upward in a substantially vertical direction from the crank case 14. A piston 12 is housed within the cylinder 11 so as to be reciprocatable in up and down directions. A clutch shaft 32 is coupled to a front side (output side) of the crank shaft 13 via a centrifugal clutch (centrifugal clutch mechanism) 29. To the clutch shaft 32, a driving shaft passing through the main pipe 1004 (see FIG. 17) although not illustrated is coupled. A fin for cooling the engine is integrally formed with a magneto-rotor 22 to which the centrifugal clutch 29 is attached. The centrifugal clutch 29 is a clutch for connecting a swinging element 30a to a clutch drum 30b through centrifugal force when a rotation speed of the crank shaft 13 is a certain speed or higher. That is, the centrifugal clutch 29 is a clutch for connecting or disconnecting the transmission of the output from the crank shaft 13 to a working tool such as a rotary blade 1012. The clutch shaft 32 is held by a housing 34 via a bearing 33 so as to be rotatable. An ignition coil 23 is provided on an outer peripheral portion of the magneto-rotor 22, which is here an upper portion thereof. A high voltage current generated at the ignition coil 23 is transmitted to an ignition plug 25 via an ignition code 24 and a plug cap 25a. A fuel tank 27 is provided below the crank case 14 of the engine 10. A mixed fuel of gasoline and two-cycle oil is put into the fuel tank 27 and is supplied to a carburetor 35 (see FIG. 2) described later.

A decompression mechanism (hereinafter referred to as “decompression”) 31 is provided at a position adjacent to a combustion chamber of the cylinder 11 (at a side surface of the cylinder 11 in FIG. 1). The decompression 31 has a mechanism of releasing a part of pressure within the combustion chamber in the start-up of the engine 10. By using the decompression 31, a compressing operation by the piston 12 is easily performed, so that the engine 10 is easy to start up. In this example, by pressing an operating unit (operating button) of the decompression 31 (by moving the operating button from a back side to a front side), the part of the pressure within the cylinder 11 is released by the decompression 31. When first combustion (initial explosion) is generated immediately after rotation of the crank shaft 13, the decompression 31 is automatically returned to the position prior to the operation by this pressure variation.

As the start-up device of the engine 10 according to the present example, two systems of a cell motor 106 and a recoil starter 40 are provided. The cell motor 106 and the recoil starter 40 are arranged inside a starter cover 9. The cell motor 106 is rotated by electric power supplied via a connecting wire 102. By the rotation of the cell motor 106, a pinion 77 provided at a rotation shaft 106a is rotated, and a gear 49 meshed with the pinion 77 is rotated. The gear 49 is held by the crank shaft 13 via a bearing 48 so as to be rotatable. When the gear 49 rotates at a high speed, a one-way clutch 78 attached to a part of the gear 49 is protruded radially outward by centrifugal force. And, the one-way clutch 78 protruded radially outward comes in contact with a first drum 79 to rotate the first drum 79, and the first drum 79 rotates the fixed crank shaft 13. The recoil starter 40 has a reel 41 on which a starter rope 42 is wound. By pulling the starter rope 42 by using a starter handle (not illustrated) so as to rotate the reel 41 at a high speed, the one-way clutch 46 is protruded radially outward by centrifugal force. And, the one-way clutch 46 protruded radially outward comes in contact with a second drum 47 so as to rotate the second drum 47. Since the second drum 47 is fixed to the crank shaft 13, the crank shaft 13 is rotated by the rotation of the second drum 47, so that the engine can be started up. The starter rope 42 pulled out from the reel 41 is wound on the reel 41 by restoring force of a spiral spring 43.

A battery housing unit 39 is provided separately from, for example, two grip portions 1009 (see FIG. 17) that are gripped by the operator. The battery housing unit 39 is provided at, for example, a handle 1008 so as to be attachable thereto/detachable therefrom. In the present example, a shape of the battery housing unit 39 is set to a shape that matches a packed-style battery 80. However, the shape of the battery housing unit can be appropriately set so as to match a shape of a battery to be mounted. For example, the battery housing unit 39 can be configured so that a plurality of types of electric-tool lithium ion battery packs, dry cell batteries, or others having different voltages can be mounted thereto. Also, the type of the battery is not limited to the lithium ion battery but may be a primary battery such as a dry cell battery or an ap-propriate secondary battery. Inside the battery housing unit 39, a battery 80 which has a substantially cylindrical shape and which is attachable/detachable is housed. The battery 80 is configured to be of so-called cassette-type battery so that it is attachable to/detachable from the battery housing unit 39. Two hook units 81a are formed at the battery 80. The battery 80 is held at the battery housing unit 39 by engaging the hook units 81a with a concave portion (not illustrated) formed on an inner wall of the battery housing unit 39. For detaching the battery 80 from the battery housing unit 39, the battery 80 is pulled out from the battery housing unit 39 while pressing a release button 81.

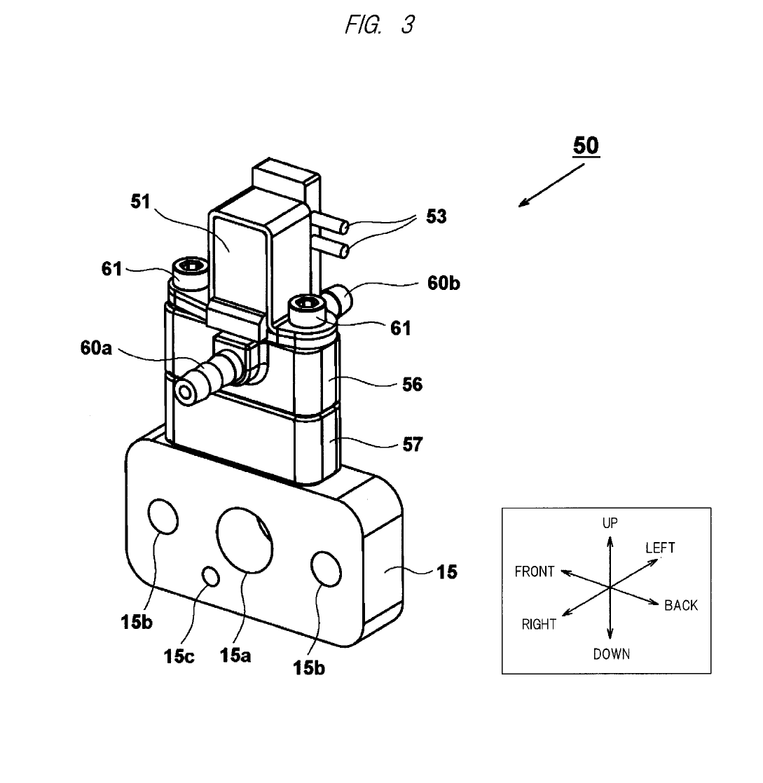

Inside the battery 80, for example, four lithium ion battery cells (not illustrated) of size 14500 are housed. A shape of a back end portion (lower side in FIG. 1) of the battery housing unit 39 is formed so as to cover an opening portion 39a on a lower end. A control circuit board 90 is provided on the other end of a mounting space for the battery 80 continued from the opening portion 39a, and a plurality of terminals 84 is provided so as to extend from the control circuit board 90 toward the opening portion 39a. The control circuit board 90 is a substrate on which a control circuit described in FIG. 3 later is mounted. A plurality of terminals 83 are provided at a front end portion (an upper side in FIG. 1) of the battery 80. By mounting the battery 80 to the battery housing unit 39, the terminals 83 of the battery 80 and the terminals 84 of the battery housing unit 39 come into contact with each other, and therefore, electric power of the battery 80 is supplied to the control circuit described later.

FIG. 2 is a longitudinal cross-sectional view illustrating an internal structure of the engine working machine 1 according to the present example. On one side (right side) of the cylinder 11, a muffler 16 is attached to the cylinder 11 by a bolt 17. On the other side (left side) of the cylinder 11, a carburetor 35 is provided. To the carburetor 35, an air cleaner box 26 housing an air filter therein is connected. The fuel tank 27 is provided below the crank case 14. The carburetor 35 generates an air-fuel mixture of air and fuel, and supplies the air-fuel mixture to the cylinder 11. An upper side portion of the engine 10 is covered with an upper portion cover 7, and the muffler 16 is covered with a muffler cover 8. The muffler 16 reduces exhaust sounds when combustion gas exhausted from the cylinder 11 is exhausted to outside. A plurality of expansion chambers are provided inside a box-shaped metallic muffler 16. In the muffler 16, a catalytic device for purifying exhaust gas may be provided. The upper portion cover 7 and the muffler cover 8 are manufactured by, for example, integral molding of synthetic resin such as plastic. In the carburetor 35, a manually-operated choke lever 36 is provided. Since a configuration and an operation of the choke lever 36 are known, detailed explanations thereof will be omitted here.

An insulator 19 is provided between the carburetor 35 and the cylinder 11. The insulator 19 forms an air intake passage and also fixes the carburetor 35. The insulator 19 is attached to the cylinder 11 by using a screw 20. The carburetor 35 is attached to the insulator 19 by using two screws 21 (while FIG. 2 illustrates only one of them). An additional fuel supplying device 50 that serves as an additional fuel supplying unit is provided between the insulator 19 and the carburetor 35. The additional fuel supplying device 50 is a device separated from the carburetor 35. That is, the additional fuel supplying device 50 and the carburetor 35 are different devices from each other. A dedicated fuel pipe for supplying the fuel to the additional fuel supplying device 50 is not used as a fuel pipe. The additional fuel supplying device 50 is provided in the middle of a path of the fuel pipe for supplying fuel from the fuel tank 27 to the carburetor 35. Therefore, while a fuel pipe 71 for supplying the fuel from the fuel tank 27 to the carburetor 35 is provided, an end portion of the fuel pipe 71 is connected to the additional fuel supplying device 50. And, a fuel pipe 73 for connection is connected to the additional fuel supplying device 50, and the fuel pipe 73 is connected to an inlet port (not illustrated) of the carburetor 35. A return pipe 74 is connected to an exhaust port (not illustrated) of the carburetor 35 for excess fuel, and an end portion of the return pipe 74 opens toward an inside of the fuel tank 27 so as to pass through a through hole 27c.

In this manner, the additional fuel supplying device 50 is arranged between the insulator 19 and the carburetor 35. Also, the additional fuel supplying device 50 is provided in the path of the fuel pipe 71 for supplying the fuel. In this manner, a fuel tank having exactly the same shape as that of a conventional device, that is, a fuel tank having two through holes 27b and 27c can be used as it is as the fuel tank 27. Moreover, since it is not necessary to change the configurations of the insulator 19 and the carburetor 35, it is not necessity to change conventional components in order to achieve the present invention, so that the present example can be easily achieved. A filter 72 is provided for preventing suction of dust at a distal end of the fuel pipe 73 on the fuel tank 72 side. Rubber bushes 76a and 76b for preventing leakage of the fuel are provided at the through holes 27b and 27c of the fuel tank 27.

The carburetor 35 is provided with a priming pump 37 for sucking the fuel from the fuel tank 27 to the carburetor 35. When the operator repeatedly pushes the priming pump 37 immediately before the start-up of the engine, the fuel is supplied to the carburetor 35 until the fuel flows to the return pipe 74. The priming pump 37 has a semispherical transparent valve unit. The operator can visually confirm that the fuel reaches the carburetor 35, from the reaching of the fuel to the transparent valve portion. Since the additional fuel supplying device 50 is provided in the middle of the path of the fuel pipe 71 provided for supplying the fuel to the carburetor 35, completion of a sucking operation of the fuel toward the carburetor 35 also means completion of a sucking operation of the fuel toward the additional fuel supplying device 50. In this manner, such a trouble that the fuel has not still reached the additional fuel supplying device 50 in the start-up of the engine 10 can be reliably prevented.

FIG. 3 is a perspective view illustrating the overall shape of the additional fuel supplying device 50 according to the present example. The additional fuel supplying device 50 has a fixing adaptor 15 serving as an attachment adaptor. The fixing adaptor 15 is fixed between the carburetor 35 and the insulator 19. In this manner, the additional fuel supplying device 50 is fixed to the engine 10. A cross-sectional shape of the fixing adaptor 15 is identical to a cross-sectional shape of the insulator 19. An air-intake path 15a is formed in the center of the fixing adaptor 15. Two screw holes 15b through which the screws 21 pass are formed on both sides of the air-intake path 15a of the fixing adaptor 15. A pulse hole 15c is formed in vicinity of the air-intake path 15a of the fixing adaptor 15. The pulse hole 15c is formed to transmit pressure of the crank case to the carburetor 35. The pressure that is transmitted through the pulse hole 15c operates a diaphragm (not illustrated) of the carburetor 35. It is preferred that the fixing adaptor 15 is integrally formed with the insulator 19 using the same resin or made of the same aluminum alloy as that of the carburetor 35. When the fixing adaptor 15 is formed of the same material as that of the insulator 19, the insulator 19 and the fixing adaptor 15 can be formed by integral molding. Also, a fuel chamber 57 may be directly attached to the insulator 19 without using the fixing adaptor 15. That is, the additional fuel supplying device 50 may be directly attached to the insulator 19. When the insulator 19 is formed by the integral molding using a resin, it is not required to change the carburetor 35 to be attached to the insulator 19 since change in the shape of the insulator 19 is easy. Accordingly, it is easy to apply the additional fuel supplying device 50 of the present example to an existing engine working machine.

The fuel chamber 57 is arranged above the fixing adaptor 15, a solenoid valve fixing unit 56 is arranged above the fuel chamber 57, and a solenoid valve 51 is arranged above the solenoid valve fixing unit 56. The fuel chamber 57, the solenoid valve fixing unit 56, and the solenoid valve 51 are fixed to the fixing adaptor 15 by using two bolts 61. The solenoid valve fixing unit 56 is provided with a fuel inlet path 60a for supplying the fuel into the additional fuel supplying device 50 and a fuel outlet path 60b for discharging fuel from the inside of the additional fuel supplying device 50. A flow path from the fuel inlet path 60a to the fuel outlet path 60b is arranged to be linear. In this manner, this arrangement does not interfere the fuel supply from the fuel tank 27 to the carburetor 35. The solenoid valve 51 is provided with two lead wires 53.

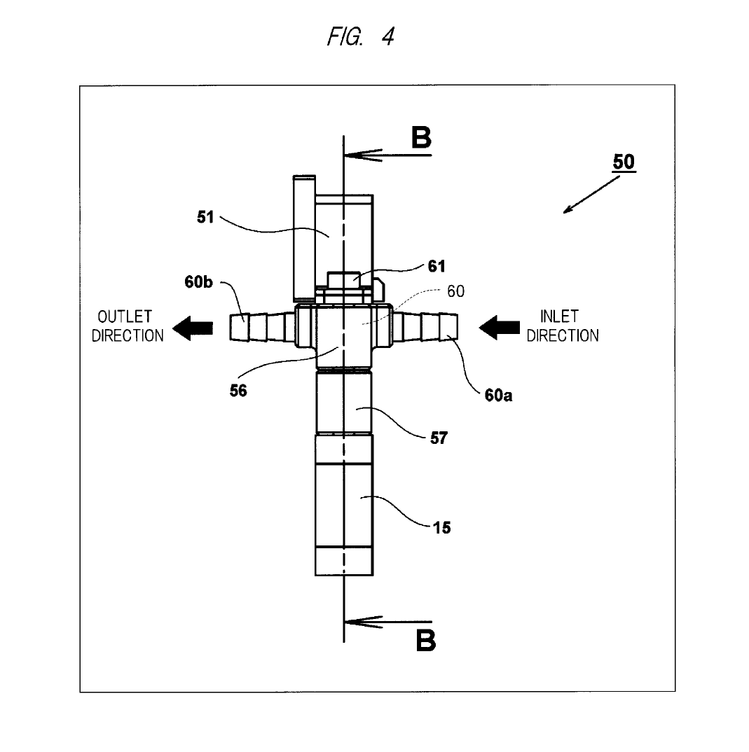

FIG. 4 is a side view of the additional fuel supplying device 50 of FIG. 2. By mounting the additional fuel supplying device 50 of the present example, a distance between the carburetor 35 and the insulator 19 is increased by a thickness of the fixing adaptor 15 (by a width thereof in right and left directions). However, the thickness is almost as the same as a thickness of the solenoid valve 51, and therefore, the thickness has no problem in the mounting and a length of the air-intake path. If the length of the intake path is desired to be adjusted, a shape of the insulator 19 can be changed. Accordingly, for the carburetor 35, a conventionally used one can be used as it is. The additional fuel supplying device 50 according to the present example is provided with the fuel inlet path 60a and the fuel outlet path 60b. This is because of not providing a dedicated fuel supply path from the fuel tank 27 to the additional fuel supplying device 50 but using the fuel pipe 71 to be shared for supplying the fuel from the fuel tank 27 to the carburetor 35. That is, this is because of using the fuel pipe 71 to be shared between the carburetor 35 and the additional fuel supplying device 50. To the fuel inlet path 60a of the additional fuel supplying device 50, the fuel is supplied from the fuel tank 27 via the fuel pipe 71. Most of the fuel supplied to the fuel inlet path 60a is supplied from the fuel outlet path 60b to the fuel pipe 73 and is supplied from the fuel pipe 73 to the carburetor 35. Accordingly, it is important that the fuel path 60 extending from the fuel inlet path 60a to the fuel outlet path 60b is configured to have a small flow path resistance, and it is configured in the present example so that an inlet direction and an outlet direction are positioned to be linear. Note that it is not always required to configure the inlet direction and the outlet direction to be linear, and a configuration in which the inlet direction and the outlet direction are bent by 90 degrees from each other may be adopted as long as the flow path resistance can be sufficiently small.

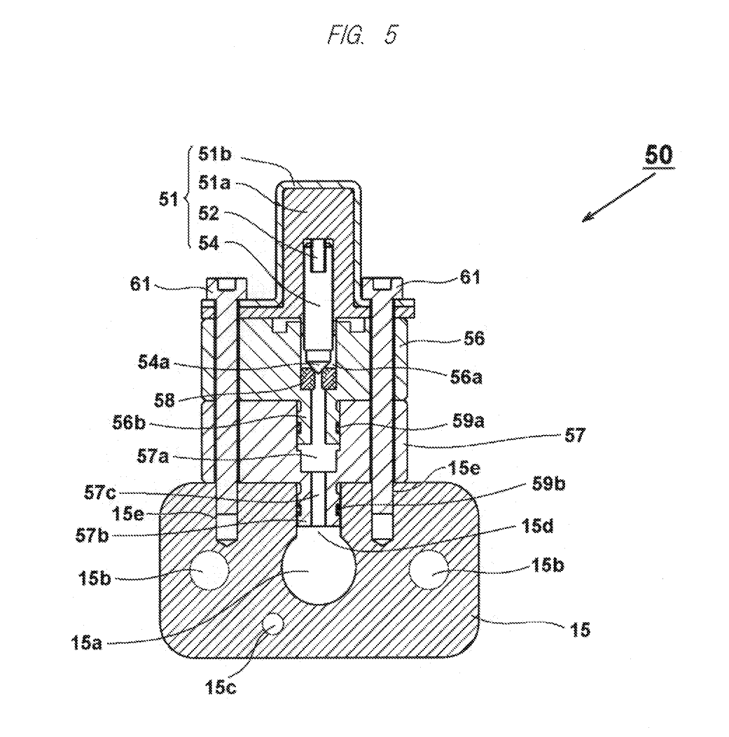

FIG. 5 is a cross-sectional view of a portion B-B in FIG. 4 which is a view illustrating an internal structure of the additional fuel supplying device 50. The solenoid valve 51 is an electric control valve which moves a plunger 54 using magnetic force of an electromagnet (solenoid) so as to open and close a valve (distal end portion 54a). In this manner, the solenoid valve 51 controls the flow of the fuel in a flow path extending from the fuel inlet path 60a (see FIG. 4) to the fuel chamber 57. The solenoid valve 51 has a main body unit 51a in which the electromagnet not illustrated is embedded. The main body unit 51a is covered with a fixing fitting 51b forming a screw seat for the bolt 61. Also, to the main body unit 51a, a lead wire 53 (see FIG. 3) for supplying electric power to the electromagnet is connected. The fixing fitting 51b of the solenoid valve 51 is fixed to the fixing adaptor 15 by using two bolts 61. The two bolts 61 are inserted into two screw holes 15e formed in the fixing adaptor 15. In the solenoid valve fixing portion 56, a space 56a connected to the fuel path 60 is formed. Also, in the solenoid valve fixing portion 56, a cylindrical plunger abutting portion 58 is provided at an outlet of a pipeline extending from the space 56a to the fuel chamber 57.

One end portion of the plunger 54 is held by a movable piece 52. On the other end portion of the plunger 54, the distal end portion 54a formed in a conical shape is formed. The flow path is closed when the distal end portion 54a contacts the plunger abutting portion 58, and the flow path is opened when the distal end portion 54a separates from the plunger abutting portion 58. Also, an amount of additional fuel flowing toward the air-intake path 15a side is adjusted depending on a distance between the distal end portion 54a and the plunger abutting portion 58. A cylindrical protruding portion 56b is formed on the outlet side of the solenoid valve fixing unit 56, and the protruding portion 56b is inserted into a cylindrical space 57a having a predetermined size. An O ring 59a is arranged at a connecting portion between the protruding portion 56b and the cylindrical space 57a for preventing leakage of the fuel from the connecting portion. A protruding portion 57b that extends toward a drain side is formed in the fuel chamber 57, and a flow path 57c is formed inside the protruding portion 57b. The protruding portion 57b of the fuel chamber 57 is attached to a cylindrical attachment hole 15d formed in the fixing adaptor 15. A bottom portion of the attachment hole 15d is opened toward the air-intake path 15a. The air-intake path 15a communicates into the crank chamber. An O ring 59b is arranged at a connecting portion between the protruding portion 57b and the attachment hole 15d for preventing leakage of the fuel from the connecting portion.

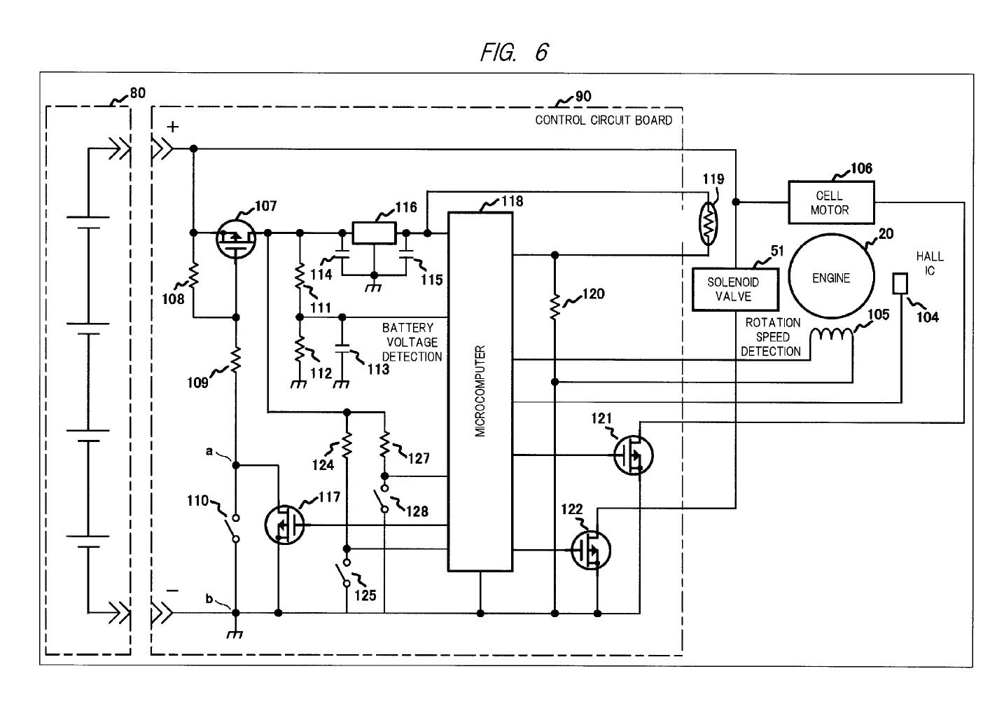

FIG. 6 is a circuit diagram of the engine working machine 1 according to the present example. As described before, the engine working machine 1 is provided with the additional fuel supplying device 50 using the solenoid valve 51. The additional fuel supplying device 50 is electronically controlled by a control circuit (control unit) mounted on a control circuit board 90. The solenoid valve 51 opens and closes a flow path for additionally injecting the fuel to the engine 10. The control circuit is configured to include: FETs 107, 117, 121, and 122; resistors 108, 109, 111, 112, 120, 124, and 127; a power switch 110; capacitors 113, 114, and 115; a regulator 116; a microcomputer 118; a thermistor 119; a starter switch 125; and a mode switch 128. Note that the mode switch 128 is a switch for setting a maintenance mode to be described later.

The microcomputer 118 is driven at a constant voltage that is supplied by the regulator 116. An output signal of the thermistor 119 that indicates a temperature of the engine 10, a signal that indicates a voltage of the battery 80 caused by the resistors 111 and 112, and an output signal of a rotation detecting coil 105 are inputted to a plurality of A/D converting ports of the microcomputer 118. An engine rotation pulse signal is a signal that indicates an engine rotation speed, that is, a rotation speed of the crank shaft 13, which is a signal that indicates change in magnetic flux of a magnet that rotates with the crank shaft 13. The change in the magnetic flux of the magnet are converted into a voltage by the rotation detecting coil 105, and this voltage signal is inputted to the microcomputer 118 and is detected as the engine rotation pulse signal. In this manner, the microcomputer 118 is functioned as a rotation-speed detecting unit for detecting the engine rotation speed. The microcomputer 118 performs predetermined logic computation using these input values, transmits a gate signal to the FETs 117 and 122, and controls conduction or interruption between a sources and a drain of the FETs 117 and 122.

The FET 121 is a switching element for controlling current supply to the cell motor 106. The source and the drain of the FET 121 are conducted to each other by an instruction of the microcomputer 118 (which is supply of the gate signal). The FET 122 is a switching element for opening the solenoid valve 51. The source and the drain of the FET 122 are conducted to each other by an instruction of the microcomputer 118 (which is supply of the gate signal). When the source and the drain of the FET 122 are conducted to each other, electric power is supplied to the solenoid valve 51 so as to open the solenoid valve 51. As described above, the solenoid valve 51 is provided in vicinity of the carburetor 35 for supplying the fuel into the cylinder 11 of the engine 10.

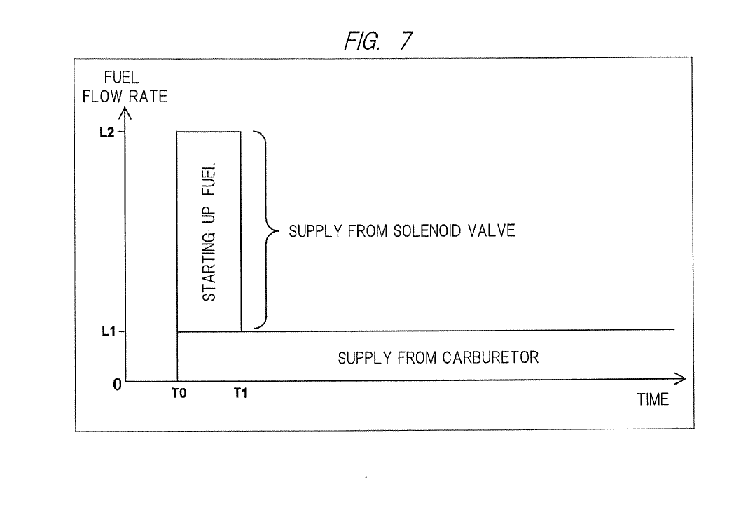

Next, a fuel supplying condition performed by the carburetor 35 and the additional fuel supplying device 50 in the engine start-up will be explained by using FIG. 7. In FIG. 7, a vertical axis indicates the fuel flow rate (unit: microliter), and a horizontal axis indicates time (unit: millisecond). FIG. 7 illustrates the fuel supplying condition in a case in which both of the carburetor 35 and the additional fuel supplying device 50 operate normally. At time “T0”, the start-up of the engine 10 is started so that a large amount of fuel (start-up fuel) is supplied into the air-intake path by the additional fuel supplying device 50 only immediately after rotation of the piston 12. At this time, since fuel is also supplied from the carburetor 35 (with a flow rate of “L1”) to the air-intake path, the fuel from the additional fuel supplying device 50 is added thereto, so that total supply is with a flow rate of “L2”. When the engine 10 starts up around the time T1, fuel supply from the additional fuel supplying device 50 is stopped. Accordingly, the fuel is supplied from only the carburetor 35 to the air-intake path extending from the carburetor 35 into the cylinder 11, and therefore, the flow rate of this supply is only the L1. Note that the illustrated fuel flow rates are conceptually explained, and therefore, they do not indicate exact values. Practically, these rates change depending on increase or fluctuation of the engine rotation speed.

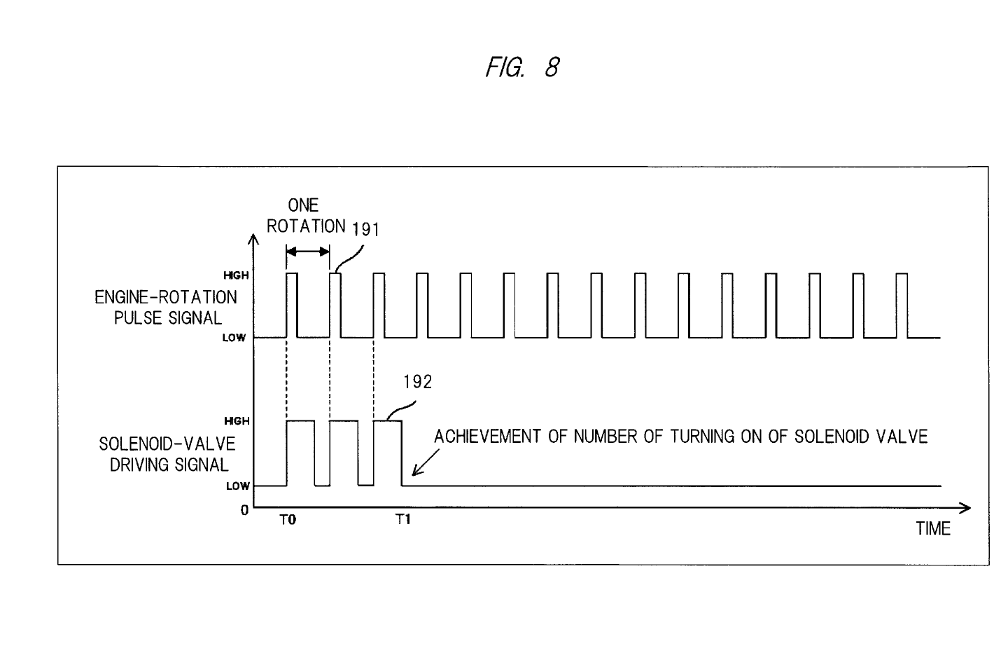

FIG. 8 is an operation timing chart of the additional fuel supplying device 50 according to an example of the present invention in the normal engine start-up. In actual start-up, the engine rotation pulse signal (which is issued once for one rotation of the crank shaft 13) is narrowed in accordance with the increases in the rotation speed of the engine 10. However, for convenience of explanation, FIG. 8 conceptually illustrates the engine rotation pulse signals at equal intervals. The additional fuel supplying device 50 opens a pipeline between the air-intake path and the fuel path 60. The additional fuel supplying device 50 intermittently supply the additional fuel to the air-intake path each time when the crank shaft 13 reaches a predetermined rotation angle. In the present example, the solenoid valve 51 is operated to open the pipeline passing from the space 56a to the fuel chamber 57 by only predetermined time or predetermined angle of rotation (by predetermined angle of the one rotation of the crank shaft 13) so as to match a timing of appearance of the output of the rotation detecting coil 105. A solenoid-valve driving signal 192 indicates a driving condition of the solenoid valve 51 at that time. When the solenoid driving signal is in a HIGH condition, the driving signal (power) is supplied to the solenoid valve 51. Accordingly, the solenoid valve 51 operates to open a valve mechanism, so that the fuel is supplied from the additional fuel supplying device 50 to the air-intake path. When the solenoid driving signal is in a LOW condition, no driving signal (power) is supplied to the solenoid valve 51. Therefore, the valve mechanism is closed by a spring mechanism (not illustrated) included in the solenoid valve 51, so that the fuel supply from the additional fuel supplying device 50 is stopped. Here, a timing of opening the solenoid valve 51 is synchronized with a rising timing of the engine rotation-speed pulse signal 191. A timing of closing the solenoid valve 51 is set to be a timing at which predetermined time has elapsed from the rising timing of the engine rotation-speed pulse signal 191 or at which the crank shaft 13 has rotated by a predetermined rotation angle. The amount of the additional fuel that is supplied to the air-intake path can be adjusted by a period length of time in which the solenoid valve 51 opens during the one rotation of the engine 10. In the present example, since the engine 10 operates normally at the time T1, rotation of the engine 10 can be maintained by only the carburetor 35 without using the additional fuel supplying device 50 after the time. Accordingly, after the time T1, the solenoid-valve driving signal 192 remains in the LOW condition, that is, the solenoid valve 51 remains not to be conducted. The control procedure in the normal engine start-up has described above, and the additional fuel supplying device 50 is functioned as a so-called automatic choke mechanism in the start-up.

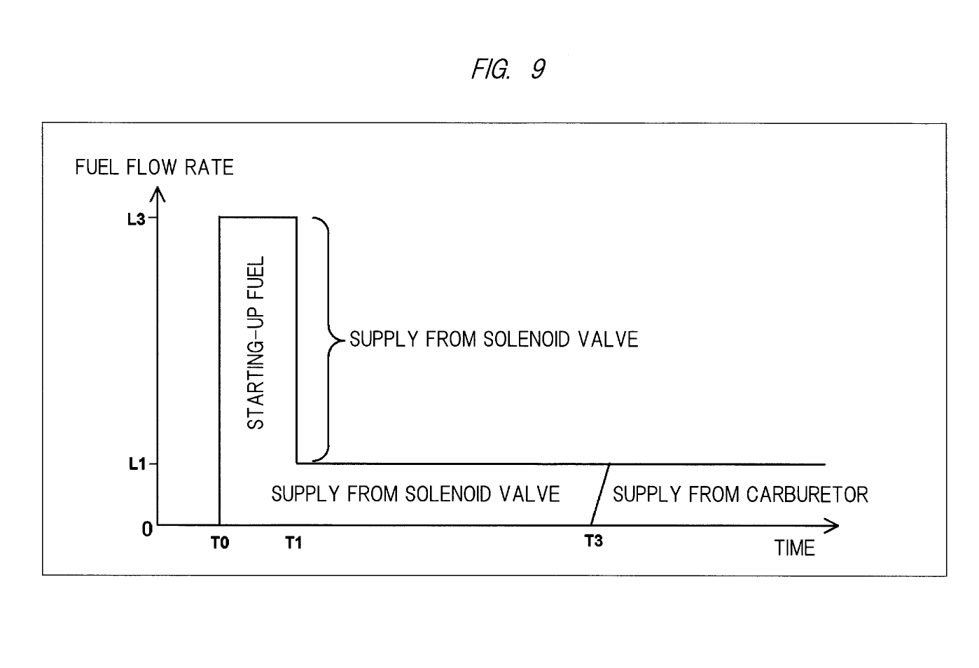

Next, a fuel supplying condition performed by the carburetor 35 and the additional fuel supplying device 50 in the engine start-up will be explained by using FIG. 9. FIG. 9 illustrates the fuel supplying condition in a state in which the engine 10 is difficult to be started up due to a failure of the carburetor 35. Note that a vertical axis and a horizontal axis of FIG. 9 are in the same relation as the vertical axis and the horizontal axis in FIG. 7. As illustrated in FIG. 9, the start-up of the engine 10 is started by the recoil starter 40 or the cell motor 106 at time “T0”. Immediately after the rotation of the crank shaft 13 starts, a large amount of fuel (start-up fuel) is supplied from the additional fuel supplying device 50 into the air-intake path. In the condition of FIG. 9, while the engine 10 is started around time T1, no fuel is supplied from the carburetor 35 to the air-intake path due to a failure of the carburetor 35. Therefore, when supply of fuel by the additional fuel supplying device 50 is stopped as in the control as explained with reference to FIG. 7, the engine 10 stops. In the control as illustrated in FIG. 9, the fuel having an amount that is originally has to be supplied from the carburetor 35 is supplied from the additional fuel supplying device 50 immediately after start-up (after time T0). In other words, the additional fuel supplying unit 50 is operated separately from supply of start-up fuel. As a result, it is made possible to maintain rotation of the engine 10 through fuel supply from the additional fuel supplying device 50. By maintaining the rotation of the engine 10, it is possible to effectively eliminate clogging of the carburetor 35 through a negative pressure inside the cylinder 11. In the case as illustrated in FIG. 9, the fuel supply from the carburetor 35 is recovered around time T3 so as to return to the normal fuel supplying condition by the carburetor 35. Therefore, fuel supply from the additional fuel supplying device 50 is stopped after time T3 to switch to fuel supply from only the carburetor 35. This switching can be electrically controlled by the microcomputer 18 (control unit). When fuel supply from the carburetor 35 is recovered around time T3, the engine rotation speed increases. Therefore, the microcomputer 118 monitors change in the engine rotation speed, and switches the driving signal of the solenoid valve 51 to LOW and maintains it as it is when the microcomputer detects increase in the engine rotation speed. Note that, in the condition of FIG. 9, since the fuel flow rate L3 of the start-up fuel is supplied from only the additional fuel supplying device 50, a usual relation is indicated as “L3 is smaller than L2” (see FIG. 7). However, it may be also possible to set the supply amount of from the additional fuel supplying device 50 to be larger so that the relation of “L3=L2” is almost satisfied.

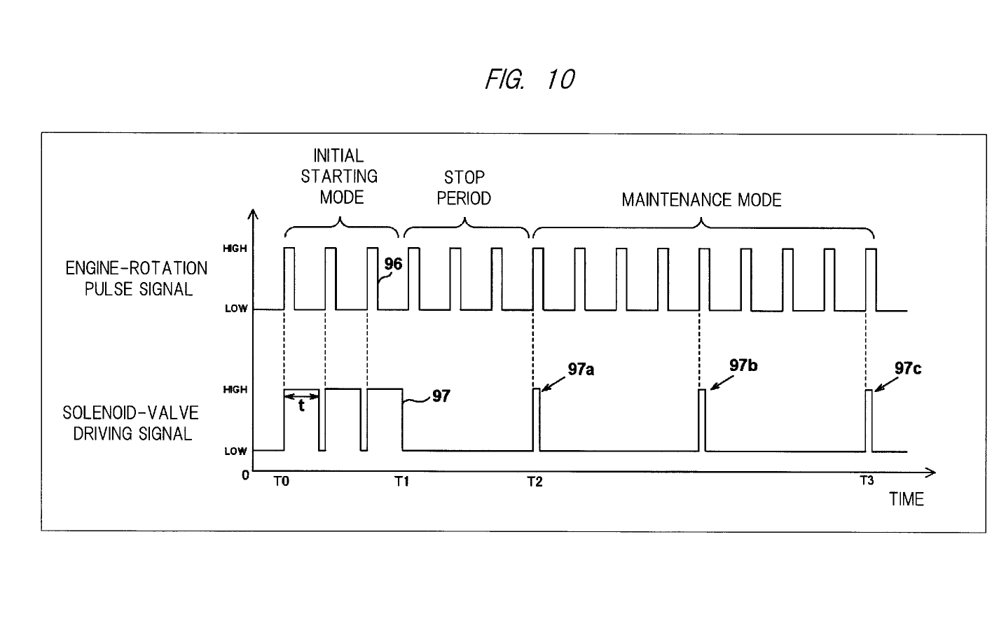

FIG. 10 is an operation timing chart of the additional fuel supplying device 50 according to an example of the present invention in the engine start-up. FIG. 10 illustrates a condition in which the additional fuel supplying device 50 executes the maintenance mode. Note that FIG. 10 also conceptually illustrates the engine rotation pulse signals 96 at equal intervals for convenience of explanation as similar to FIG. 8. In this example, the solenoid valve 51 is operated to open the pipeline extending from the space 56a to the fuel chamber 57 by only predetermined time or predetermined rotation angle (predetermined angle of one rotation of the crank shaft 13) so as to match a timing of appearance of the output of the rotation detecting coil 105. The solenoid-valve driving signal 97 indicates a driving condition of the solenoid valve 51 at that time. When the solenoid driving signal is in a HIGH condition, a driving signal (power) is supplied to the solenoid valve 51, and therefore, the solenoid valve 51 operates to open the valve mechanism. When the solenoid driving signal is in a LOW condition, no driving signal (power) is supplied to the solenoid valve 51 to close the valve mechanism. Here, the timing of opening the solenoid valve 51 is synchronized with a rising timing of the engine rotation pulse signal 96. The timing of closing the solenoid valve 51 is a timing at which predetermined time has elapsed from the rising timing of the engine rotation pulse signals 96 or at which the crank shaft 13 has rotated by a predetermined rotation angle. As illustrated in FIG. 10, the amount of fuel supply from the additional fuel supplying device 50 is adjusted in an initial start-up mode in the present example by setting time “t” during which the solenoid valve 51 is opened to be longer than that of the example of the normal start-up mode as illustrated in FIG. 8.

As illustrated in FIG. 10, while the engine is normally started-up at time T1, the fuel from the carburetor 35 is hardly supplied since the carburetor 35 is clogged at that time. Accordingly, in stop time after elapse of the start-up initial mode, the microcomputer 118 determines whether to execute the subsequent maintenance mode. When the microcomputer 118 determines to execute the maintenance mode, output of the solenoid-valve driving signal 97 in the HIGH condition is started at time T2. Then, as illustrated by arrows 97a, 97b and 97c in FIG. 10, the solenoid-valve driving signals 97 are supplied for a short period of time at predetermined time intervals, so that an amount of fuel required for maintaining an idling engine rotation speed of the engine 10 is supplied from the additional fuel supplying device 50 into the air-intake path. As a result, the engine 10 continuously rotates without stopping even when clogging of the carburetor 35 is caused, so that the clogging of the carburetor 35 can be effectively eliminated by the negative pressure inside the cylinder 11. Then, at time T3 which is a point of time after elapse of a predetermined time or after completion of a predetermined rotation, the microcomputer 118 ends execution of the maintenance mode, and switches to fuel supply from only the carburetor 35.

Here, it is determined whether to shift to the maintenance mode or not by any one of follows.

(1) A switch (mode switch 128) dedicated for instructing execution of the maintenance mode is provided to execute the maintenance mode in accordance with setting of the mode switch 128.

(2) The microcomputer 118 monitors the change in the engine rotation speed during the stop time, and executes the maintenance mode when it is determined that rotation is difficult to be maintained such that the rotation decreases.

(3) An engine stop period taken from the previous engine stop is calculated, and the maintenance mode is executed when the calculated stop time exceeds a predetermined value.

(4) The shift determination is made when the microcomputer 118 determines to execute the maintenance mode from the above-described conditions or from a different condition from the above-described conditions (such as engine temperature or outside air temperature).

In the present example, the additional fuel is supplied in the maintenance mode by opening the solenoid valve 51 during only one rotation of four rotations of the crank shaft 13. That is, in the maintenance mode, the additional fuel is supplied from the additional fuel supplying device 50 during one rotation of “m” rotations (here, “m is equal to or larger than 2”) of the engine 10. Note that the term of “m” rotations of the engine 10 indicates a term of “m” rotations of the crank shaft 13. In this manner, in the maintenance mode, the fuel is not supplied from the additional fuel supplying device 50 each time when the engine 10 rotates as in the initial start-up mode, but intermittently supplied from the additional fuel supplying device 50. While a relation of “m=4” is set in the present example, the present invention is not limited to this relation but the fuel may be supplied from the additional fuel supplying device 50 at any interval as long as the idling engine rotation speed of the engine 10 can be maintained without supplying the fuel from the carburetor 35. Further, a frequency of the supply of the fuel from the additional fuel supplying device 50 is not always required to be one rotation of “m” rotations (here, “m is equal to or larger than 2”) but may be “n” rotations (here, “m is larger than n”) of “m” rotations (here, “m is equal to or larger than 2”). It is important here to maintain the idling condition normally without the stop of the engine 10. The solenoid valve 51 of the present example is switched into two stages of an open stage and a close stage. Therefore, the amount of fuel that is supplied into the air-intake path from the additional fuel supplying device 50 is adjusted by the length of time required for opening the solenoid valve 51. Here, if an electrically con-trollable adjustment valve which can also control the flow rate is used as the solenoid valve 51, it is also possible to employ a configuration in which a small amount of the fuel is supplied for each rotation in the maintenance mode.

As explained above, in the normal start-up mode, the solenoid valve 51 is turned ON during only initial some rotations in synchronization with the engine rotation pulse signal as illustrated in FIG. 8. On the other hand, as illustrated in FIG. 10, the solenoid valve 51 is turned ON during a relatively long time each time of rotation over initial some rotations in the initial start-up mode, and then, the solenoid valve 51 is turned ON during a relatively short time at a timing of once per some rotations of the engine 10 in the maintenance mode. In this manner, it is possible to prevent misfire of the ignition plug 25 due to high concentration of the fuel after the start-up of the engine 10, so that the engine 10 can be driven with an optimal air-fuel ratio. Also even when the carburetor 35 clogs, clogging of the carburetor 35 can be effectively eliminated by driving the engine 10.

For example, while mixed fuel obtained by mixing gasoline and fuel is used as the fuel in a two-cycle engine, this becomes a cause for worsening the startability of the engine if this mixed fuel is left over a long period of time. By degradation of the oil in the mixed fuel, a viscosity of the oil is increased to change the oil into a gum-like texture, which results in such a problem that the inside of the carburetor 35 clogs. It is possible to solve these problems by executing the maintenance mode using the additional fuel supplying device 50.

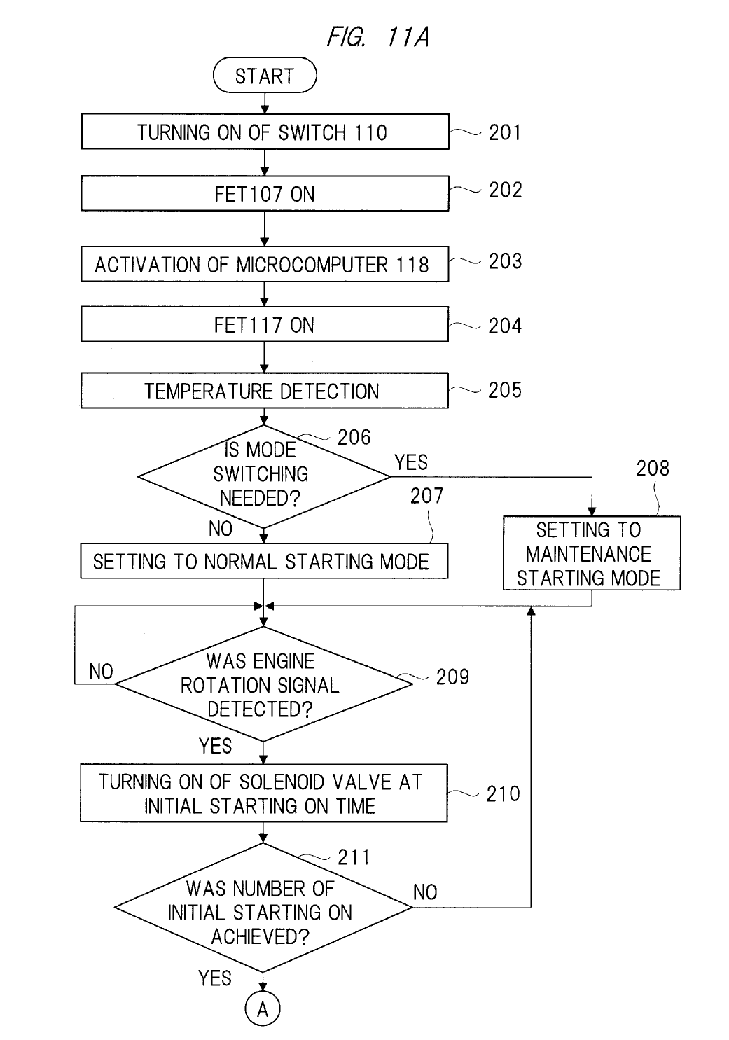

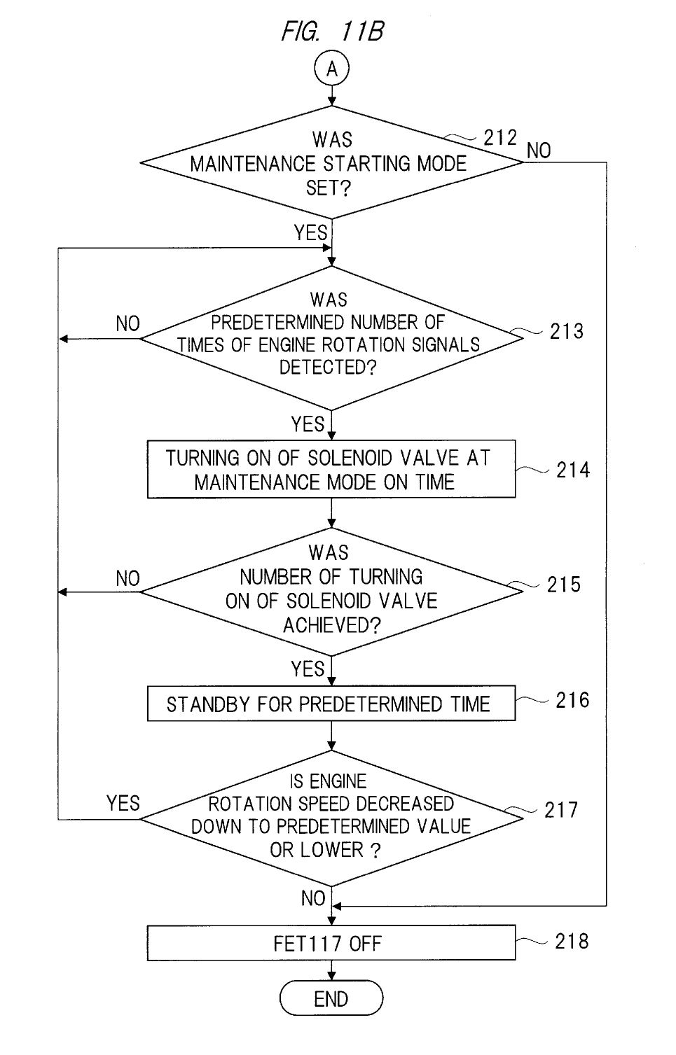

Next, the series of operations of the engine working machine 1 according to the present invention will now be explained using the flowcharts of FIGS. 11A and 11B and the circuit diagram of FIG. 6. Note that the flowchart of FIG. 11A and the flowchart of 11B are connected by a symbol “A”. First, when the power source switch 110 for the control circuit (control unit) is switched ON (Step 201), the gate voltage of the FET 107 is applied by the resistors 108 and 109. The FET 107 is accordingly switched ON (Step 202), and a voltage is supplied to the regulator 116. The regulator 116 is a constant voltage source, and is for supplying a constant voltage to the microcomputer 18 and others. Also, the capacitors 114 and 115 are for stabilizing an output voltage of the regulator 116. When a predetermined voltage is inputted to a power source terminal of the microcomputer 118, the microcomputer 118 is activated (Step 203). Next, the microcomputer 118 turns the FET 117 ON (conducts between the source and the drain) by supplying a gate signal so as to continuously maintain the ON condition of the FET 107 even after the open of the power source switch 110 (Step 204).

Next, in Step 205, the microcomputer 118 detects a temperature based on an output signal from the thermistor 119. This temperature detection is performed by inputting a voltage that has been divided by the thermistor 119 and the resistor 120 into an A/D converting input terminal of the microcomputer 118. As for a position for arranging the thermistor 119, it may be mounted at a part of the engine 10 when the temperature of the engine 10 is desirably measured, or it may be mounted at the control circuit board 90 when the outside air temperature is desirably measured. In accordance with the detected temperature, the microcomputer 118 determines the number of times of the turning ON of the solenoid valve 51 in the engine start-up and the ON time for once. More specifically, the lower the temperature is, the more the number of times of turning the solenoid valve 51 ON is, and the more the amount of fuel to be added is. For example, in the example of FIG. 10, while the solenoid valve 51 is turned ON for three rotations during the time T0 to T1, that is, only three times, the number of times of supplying fuel is previously set in accordance with the temperature, and additional fuel is supplied to the engine 10 while rotations for the set number of times are performed. In this manner, the microcomputer 118 is functioned as a temperature detecting unit for detecting the temperature of the engine 10 or the outside air. The microcomputer 118 which is also functioned as a control unit controls the amount of fuel to be added in accordance with the engine temperature or the outside air temperature.

Next, in Step 206, the microcomputer 118 determines whether a mode switch is necessary or not. This mode switch is to select either the normal start-up mode (during which the additional fuel supplying device 50 is operated in only the initial start-up control as illustrated in FIG. 7) or the maintenance mode (during which the maintenance mode as illustrated in FIG. 9 is executed to operate the additional fuel supplying device 50 after the initial start-up control). In the present example, when the mode switch 128 is OFF, the procedure proceeds to Step 207 to set the operation control mode of the solenoid valve 51 to the normal start-up mode. When the mode switch 128 is ON, the procedure proceeds to Step 208 to set the operation control mode of the solenoid valve 51 to the maintenance mode. Next, the microcomputer 118 detects whether the engine rotation pulse signal has been detected or not (Step 209) and stands-by until it is detected. The engine rotation pulse signal can be detected by output of the rotation detecting coil 105.

Here, when the operator pulls the starter handle or pushes the starter switch 125 of the cell motor 106, the engine 10 starts to rotate so that an engine rotation pulse signal is generated at the rotation detecting coil 105 each time when one rotation of the engine 10 is performed. When the microcomputer 118 detects the engine rotation pulse signal, the procedure proceeds to Step 210. In Step 210, the FET 122 is turned ON during only the ON time for one rotation determined in Step 205 to open the solenoid valve 51 so as to supply fuel from the additional fuel supplying device 50.

Next, the procedure proceeds to Step 211 to determine whether the number of ON times of the solenoid valve 51 has reached the number of ON times determined in Step 205 or not. If it has not reached the target number of ON times, the procedure returns to Step 209 to stand-by a next engine rotation pulse signal. Steps 209 to 211 are repeated, and the procedure proceeds to Step 212 at the point of time the target number of ON times has been reached.

Next, in Step 212, it is determined whether the maintenance mode is set or not. When the maintenance mode is not set, the procedure proceeds to Step 216 to turn the FET 117 OFF. Since the FET 107 is also turned OFF by turning the FET 117 OFF, the power source of the control circuit is shutdown. When it is determined in Step 212 that the maintenance mode is set, the procedure proceeds to Step 213. The maintenance mode can be divided into two modes of the initial start-up mode for supplying the large amount of fuel for a predetermined period of time at an initial stage as similar to the normal start-up mode and the maintenance mode for continuing the supply of the large amount of fuel without operating the carburetor 35 after the start-up of the engine. After Step 213, the mode is the latter one of the maintenance mode. The microcomputer 118 determines whether the engine rotation pulse signal has been detected a predetermined number of times or not, and the procedure proceeds to Step 214 at a point when it has been detected the predetermined number of times. In Step 214, the FET 122 is turned ON during only the ON time for one rotation in the maintenance mode determined in Step 205 to open the solenoid valve 51 so as to supply fuel from the additional fuel supplying device 50.

Next, the procedure proceeds to Step 215, and it is determined whether the number of ON times of the solenoid valve 51 has reached the number of ON times (three times in the example of FIG. 10) in the maintenance mode determined in Step 205 or not. Here, if it has not reached the target number of ON times, the procedure returns to Step 213 to stand-by the next engine rotation pulse signal. Steps 213 to 215 are repeated, and the procedure proceeds to Step 216 at a point when it has been reached the target number of ON times. After the stand-by for a predetermined period of time in Step 216, then, the procedure proceeds to Step 217, and it is determined whether the engine rotation speed decreases down to a predetermined value or lower. When it is determined in Step 217 that the engine rotation speed is the predetermined value or lower (when the carburetor 35 is not operating normally), the procedure returns to Step 213 to repeat Steps 213 to 217. When it is determined in Step 217 that the engine rotation speed exceeds the predetermined value (when the carburetor 35 is operating normally), the power source of the control circuit is shut-down by turning the FET 117 OFF.

As described above, according to the present example, the additional fuel supplying device 50 is provided separately from the carburetor 35, and therefore, it is possible to supply fuel from the additional fuel supplying device 50 even though the carburetor 35 has the failure, and it is possible to improve the startability of the engine 10. Moreover, since the additional fuel supplying device 50 is provided separately from the carburetor 35, it is possible to employ a conventional carburetor 35 as it is, so that the cost of the engine working machine 1 can be reduced. Further, in the normal start-up mode, supply of fuel from the solenoid valve 51 is successively (once or more within each rotation) performed in addition to fuel supply from the carburetor 35. However, in the maintenance mode, supply of fuel from the solenoid valve 51 is intermittently performed for a predetermined period of time immediately after start-up. By the provision of such a maintenance mode, it is possible to reliably start the engine 10 up and to effectively remove clogging of the carburetor 35. Note that it is determined whether the maintenance mode is executed or not by the operating condition of the mode switch 128 in the flowchart of FIG. 11. However, it is also possible to change this determination control. For example, it is also possible to set the step period for control of the solenoid valve 51 immediately after initial start-up control in FIG. 10 and to observe the engine rotation pulse signals 96 during this period. In this case, it is determined whether the carburetor 35 is operating normally during the stop period. Then, when it is determined that the carburetor 35 is not operating normally, for example, when the engine rotation speed does not increase up to a predetermined value or higher during the stop period, the maintenance mode of Steps 213 to 217 is executed. It is also possible that the microcomputer 118 measures time during which the engine 10 stops and automatically executes the maintenance mode when the calculated stop time exceeds a predetermined time (for example, whether the period of time is a long time for one month or longer). In this case, the microcomputer 118 is functioned as a timer unit for counting the stop time of the engine 10. Moreover, it is possible to make the microcomputer 118 determine whether the microcomputer 118 is necessary to execute the maintenance mode or not in consideration of other conditions (such as the engine temperature or the outside air temperature) in addition to the above-described conditions.

In the foregoing, the present invention has been concretely described based on the example. However, it is needless to say that the present invention is not limited to the foregoing example and various modifications and alterations can be made within the scope of the present invention. For example, in the above-described example, the explanation has been made by exemplifying the brush cutter as the example of the engine working machine. However, not only the brush cutter but also other engine working machines such as a cutter, a chain saw, a lawn mower, and a cultivator may be adopted. Moreover, while the above-described example has been explained with the example of the two-cycle engine, an engine working machine equipped with a four-cycle engine may be adopted.

### Second Example

A second example of the present invention will now be explained with reference to the drawings. As similar to the above-described the first example, explanations will be made so that directions in front and back, right and left, and up and down are the directions as illustrated in the drawings also in the second example. Also, members and parts that are identical to the above-described members and parts are denoted by the same reference symbols, and explanations thereof will be omitted. While explanations are made by exemplifying the brush cutter as the example of the engine working machine 501 according to the present example, explanations of the external shape of this brush cutter is omitted since the external shape thereof is identical to that as illustrated in FIG. 17. Moreover, the engine working machine 501 according to the present example has an additional fuel supplying device 50 that is functioned as an additional fuel supplying unit as similar to the above-described engine working machine 1. Since the configuration of the additional fuel supplying device 50 is identical to the above-described configuration, explanations thereof will be omitted.

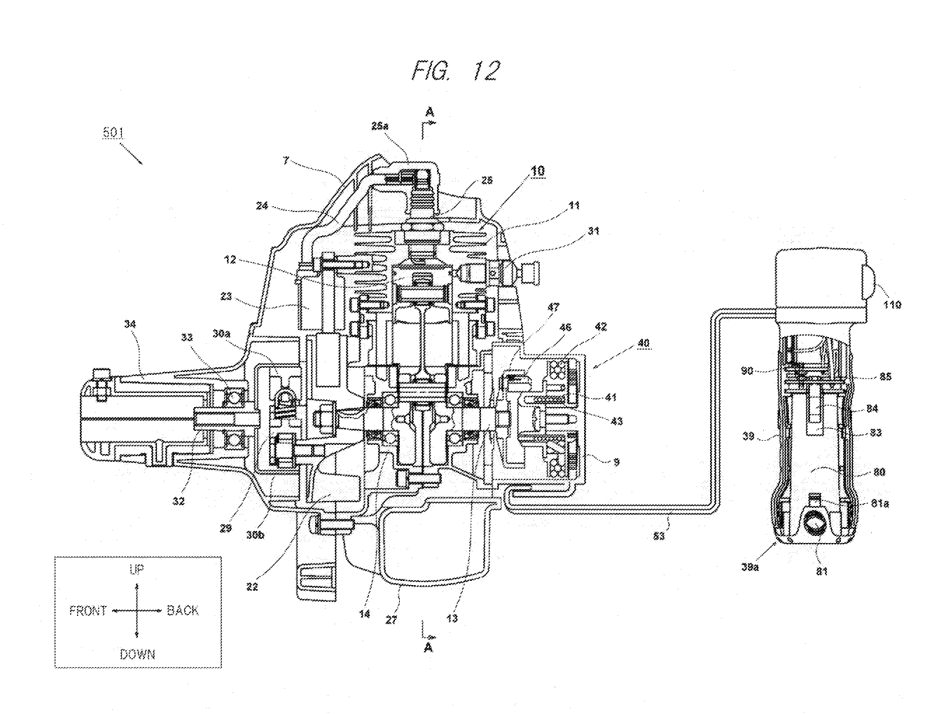

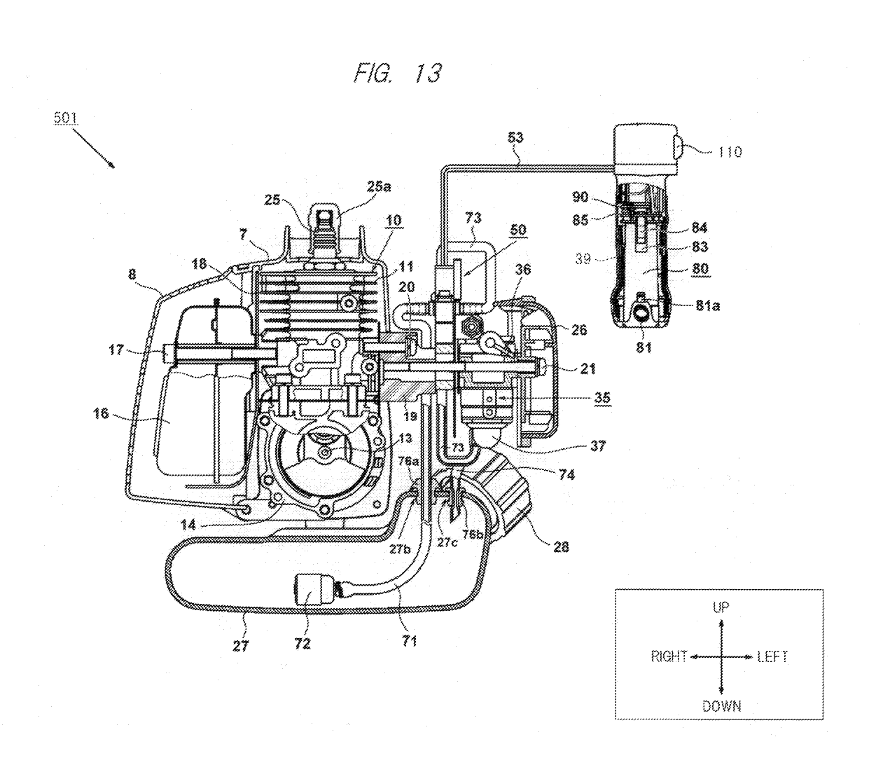

FIG. 12 is a longitudinal cross-sectional view illustrating an internal structure of the engine working machine 501 according to the present example. FIG. 13 is a cross-sectional view taken along a line A-A of FIG. 12. As illustrated in FIGS. 12 and 13, the engine working machine 501 is provided with an engine 10. An additional fuel supplying device 50 equipped with a solenoid valve 51 is provided between an insulator 19 and a carburetor 35 of the engine 10. A power source switch 110 of the additional fuel supplying device 50 is provided at a battery housing unit 39. The engine working machine 501 as illustrated in FIG. 12 has only a recoil starter 40 as a start-up device for the engine 10. However, the present example is not limited to this, and a cell motor 106 may also be provided as the start-up device as similar to the engine working machine 1 as illustrated in FIG. 1.

When the engine 10 is desirably started up, the operator operates to turn the power source switch 110 ON, and then, the operator pulls a starter handle of the recoil starter 40. Although not illustrated in the drawings, it is preferred to provide an LED or others that is lighted in conjunction with the power source switch 110 in vicinity of the power source switch 110. By the provision of such an LED, the operator can easily identify whether the power source switch 110 is in the ON or OFF condition. As described later, since the additional fuel supplying device 50 is automatically turned OFF, it is not necessary for the operator to turn the power source switch 110 OFF. For stopping the engine 10 during driving, the operator pushes a stop switch not illustrated. The stop switch is a so-called kill switch that stops ignition of the engine 10. The stop switch is provided at any position on the engine 10 side (for example, at an upper cover 7).

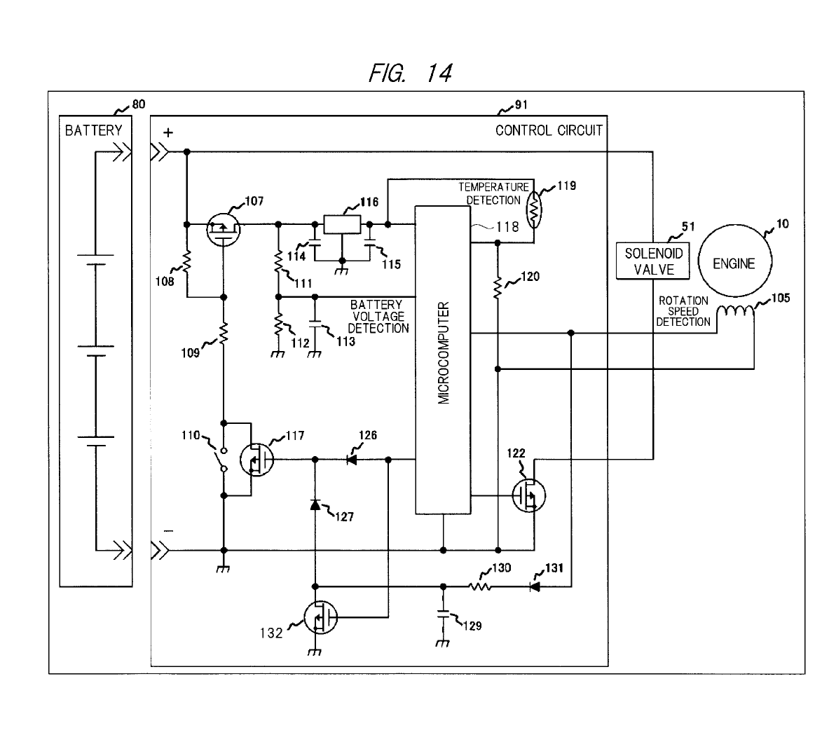

For example, four lithium ion battery cells (not illustrated) of size 14500 are embedded into a battery 80 that is housed in the battery housing unit 39. A shape of a back end portion (lower side in FIG. 12) of the battery 80 is formed to cover an opening portion 39a on a lower end of the battery housing unit 39. A terminal base 85 is provided on the other end of a mounting space of the battery 80 continued from the opening portion 39a, and a plurality of terminals 84 are provided to extend from the terminal base 85 toward the opening portion 39a. A plurality of terminals 83 are provided at a front end portion (upper side in FIG. 12) of the battery 80. By mounting the battery 80 to the battery housing unit 39, the terminals 83 of the battery 80 and the terminals 84 of the battery housing unit 39 are in contact with each other. In this manner, electric power of the battery 80 is supplied to a control circuit 91 mounted on a control circuit board 90 (described later in FIG. 14) via the terminals 84.

FIG. 14 is a circuit diagram of the engine working machine 501 according to the present example. As described above, the engine working machine 501 is provided with the additional fuel supplying device 50 using the solenoid valve 51. The solenoid valve 51 is electrically controlled by the control circuit 91 (control unit) mounted on the control circuit board 90 (see FIG. 12). The solenoid valve 51 opens and closes a path for additionally injecting fuel to the engine. The control circuit 91 is configured to include: four FETs 107, 117, 122 and 132; resistors 108, 109, 111, 112, 120, 130; a power source switch 110; capacitors 113, 114, 115 and 129; a regulator 116; a microcomputer 118; a thermistor 119; and diodes 126, 127 and 131.

The microcomputer 118 is driven at a constant voltage that is supplied by the regulator 116. An output signal of the thermistor 119 that indicates a temperature of the engine 10, a signal that indicates a voltage of the battery 80 caused from the resistors 111 and 112, and an output signal of a rotation detecting coil 105 are inputted to a plurality of A/D converting ports of the microcomputer 118. An engine rotation signal is a signal that indicates an engine rotation speed, that is, the rotation speed of a crank shaft 13, and is a signal that indicates change in magnetic flux of the magnet that rotates with the crank shaft 13. The change in magnetic flux of the magnet is converted into a voltage by the rotation detecting coil 105, and is detected as an engine rotation pulse signal when the voltage signal is inputted to the microcomputer 118. The microcomputer 118 performs a predetermined logic computation using these input values, transmits a gate signal to the FETs 117, 122 and 132, and control conduction and interruption between a source and a drain of the FETs 117, 122 and 132.

The FET 122 is a switching element for opening the solenoid valve 51. The source and the drain of the FET 122 are conducted to each other by an instruction (supply of the gate signal) of the microcomputer 118. When the source and the drain of the FET 122 are conducted to each other, electric power is supplied to the solenoid valve 51 so as to open the solenoid valve 51. By the opening of the solenoid valve 51, additional fuel is supplied to a combustion chamber of the engine 10 separately from the fuel (air-fuel mixture) that is supplied from the carburetor 35. When the supply of the gate signal from the microcomputer 118 stops, the source and the drain of the FET 122 are in a non-conducted condition. In the non-conducted condition between the source and the drain of the FET 122, a plunger 54 (see FIG. 5) of the solenoid valve 51 returns to an initial position by spring action, so that additional supply of fuel is stopped.

In the present example, the microcomputer 118 is started so that the solenoid valve 51 can be driven when the operator turns the power source switch 110 ON in the start-up of the engine. While it is possible to configure the microcomputer 118 to operate full time after the start-up of the engine 10, this adversely results in consumption of power of the battery 80 in this case. The control circuit 91 accordingly has the capacitor 129 as a storage unit for storing power that is generated by the rotation detecting coil 105. When the voltage of the capacitor 129 reaches a predetermined voltage, gate current having a predetermined voltage is carried from the capacitor 129 to the FET 117 so that this condition is maintained in the same condition in which the power source switch 110 is turned ON. In this manner, during the rotation of the engine 10, the microcomputer 118 is activated each time when a predetermined amount of electric charge is stored in the capacitor 129. The activated microcomputer 118 outputs the gate signal to the FET 132 so as to maintain the FET 117 in the ON condition and prevents charging of electric charge to the capacitor 129. The time at which the electric charge of the capacitor 129 reaches a predetermined voltage can be adjusted by a capacitance of the capacitor 129 and the resistor 130. The diodes 126, 127 and 131 are provided for preventing reverse current. In the control circuit 91 of the present example, the microcomputer 118 releases the ON condition of the FET 117 after elapse of a predetermined time to interrupt its own power source. Then, the charging to the capacitor 129 is started by power that is induced by the rotation detecting coil 105. When the charge to the capacitor 129 is completed and the voltage applied from the capacitor 129 to the FET 117 reaches a predetermined voltage, the FET 117 is switched to the ON condition, so that the microcomputer 118 is again activated. In this manner, the microcomputer 118 is periodically activated by the power stored in the capacitor 129. After elapse of a predetermined time after the activation, the microcomputer 118 interrupts its own power source. That is, the microcomputer 118 is in the ON condition for only short time for each constant period. In such a period, for example, the microcomputer 118 is set to be activated every 2 or 3 seconds during the rotation of the engine 10 and is stopped after 1 or 2 seconds so that these ON-OFF conditions of the microcomputer 118 are repeated.

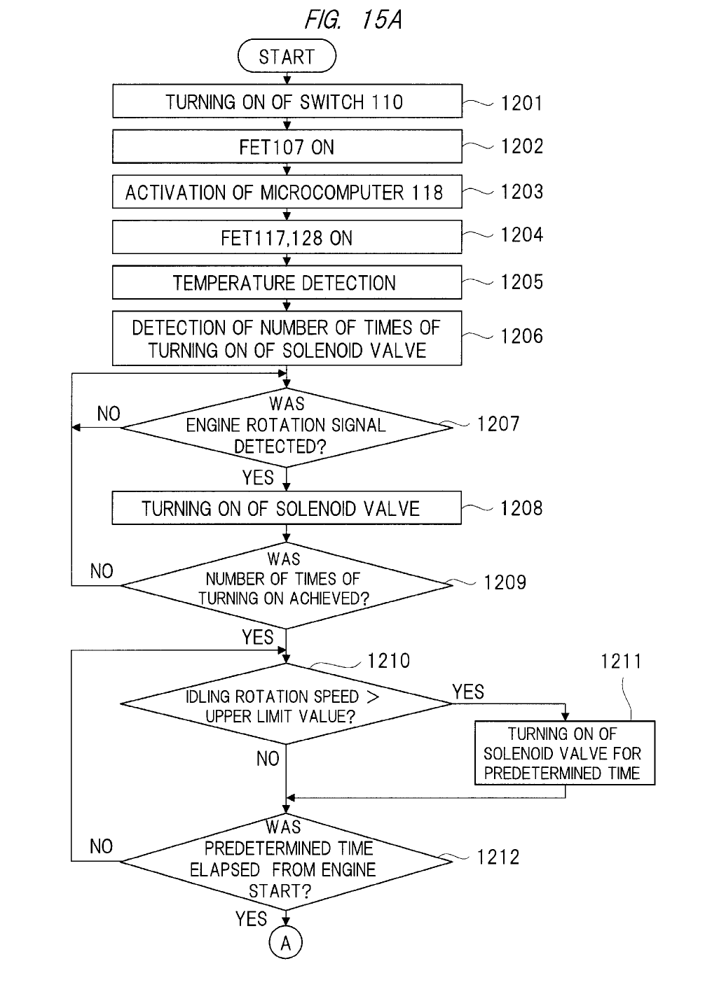

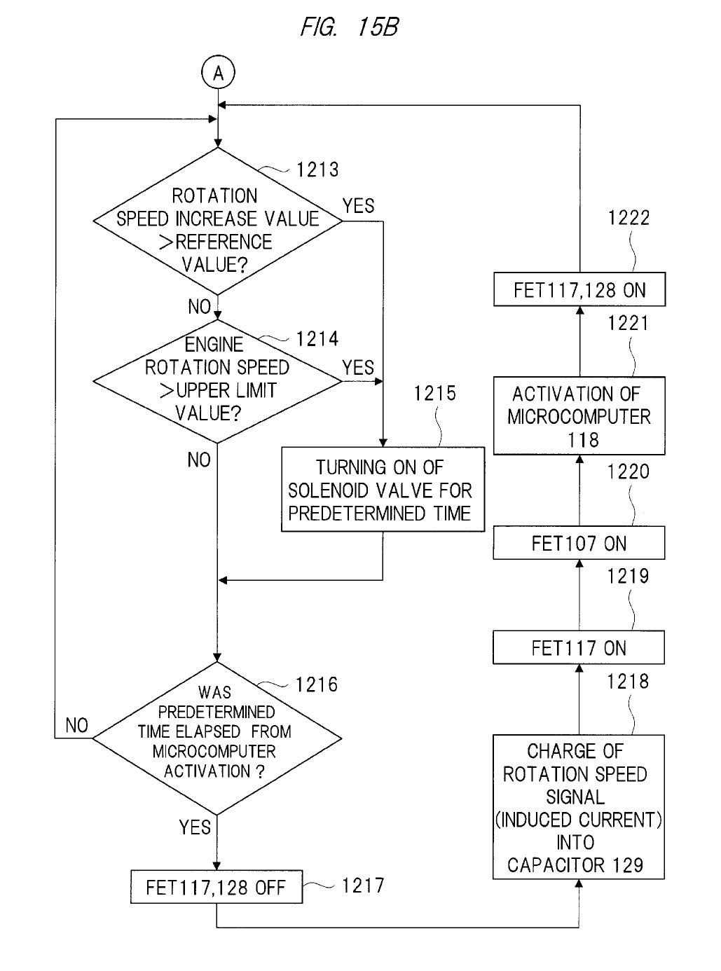

Next, a series of operations of the engine working machine 501 according to the present invention will be explained using the flowcharts of FIGS. 15A and 15B. Note that the flowchart of FIG. 15A and the flowchart 15B are connected to each other by a reference symbol “A”. First, when the power source switch 110 for the additional fuel supplying device 50 is turned ON (Step 1201), the gate voltage of the FET 107 is applied by the resistors 108 and 109. The FET 107 is accordingly in the ON condition (Step 1202) so that a voltage is supplied to the regulator 116. The regulator 116 is a constant voltage source and is for supplying a constant voltage to the microcomputer 18 and others. The capacitors 114 and 115 are for stabilizing the output voltage of the regulator 116. When a predetermined voltage is inputted to a power source terminal of the microcomputer 118, the microcomputer 118 is activated (Step 1203). Next, the microcomputer 118 supplies the gate signal, so that the FETs 117 and 132 are turned ON (conducts between the source and the drain) to continuously maintain the ON condition of the FET 107 even after the power source switch 110 is opened (Step 1204). Further, by simultaneously turning the FET 132 ON, the voltage charged to the capacitor 129 is once discharged.

Next, in Step 1205, the microcomputer 118 detects a temperature based on an output signal from the thermistor 119. This temperature detection is performed by inputting a voltage divided by the thermistor 119 and the resistor 120 to an A/D converting input terminal of the microcomputer 118. As for a position at which the thermistor 119 is arranged, the thermistor 119 may be mounted to, for example, a part of the engine 10 when the temperature of the engine 10 is desirably measured. When the outside air temperature is desirably measured, the thermistor 119 may be mounted to, for example, the control circuit board 90. In accordance with the detected temperature, the microcomputer 118 determines the number of times of turning ON of the solenoid valve 51 (Step 1206). The timing for turning the solenoid valve 51 ON may be determined in accordance with a position of the piston 12 during one rotation of the engine 10 (the solenoid valve is opened and closed only once during one rotation of the engine). The control may be performed so that the solenoid valve 51 is opened intermittently “n” times during “m” rotation of the engine 10 (here, “m is equal to or larger than n”). At this time, the lower the temperature is, the more the number of turning ON of the solenoid valve 51 is, and the more the amount of fuel to be added is. Note that there is a risk that the engine 10 stops, that is, there is a risk that the ignition plug 25 misfires when the solenoid valve 51 is continuously controlled to be opened except for the case in which a large amount of fuel is required for acceleration. It is accordingly important to set an optimal amount of additional fuel in accordance with the condition of combustion. The microcomputer 118 may store optimal values of a relation between the number of times of turning ON of the solenoid valve 51 and the temperature and a relation between the number of times of turning ON of the solenoid valve 51 and the engine rotation speed.

Next, the microcomputer 118 detects whether a rotation signal of the engine 10 has been detected or not (Step 1207), and stands-by until it is detected. The rotation signal of the engine 10 can be detected by the output of the rotation detecting coil 105. Here, when the operator pulls the non-illustrated starter handle of the coil starter 40, the engine 10 starts to rotate, so that an engine rotation signal is generated at the rotation detecting coil 105 each time when one rotation of the engine 10 is performed. When the microcomputer 118 detects the engine rotation signal, the procedure proceeds to Step 1208. In Step 1208, the FET 122 is turned ON for predetermined time to conduct the solenoid valve 51, so that a plunger abutting portion 58 (see FIG. 5) that had been closed at a distal end portion 54a of a plunger 54 is opened. In this manner, additional fuel is injected from the additional fuel supplying device 50 so as to improve the startability of the engine 10.

Next, the procedure proceeds to Step 1209 to determine whether the number of times of turning ON of the solenoid valve 51 has reached the predetermined number of times (for example, ten times) or not. When the number has not reached ten times here, the procedure returns to Step 1207 to stand-by the next engine rotation signal. Steps 1207 to 1209 are then repeated, and the procedure proceeds to Step 1210 at a point when the number of times of turning ON of the solenoid valve 51 has reached ten times. Next, the procedure proceeds to Step 1210 so as to monitor the idling rotation speed at the initial stage of the engine start-up. The monitoring of the idling rotation speed from the beginning of the engine start until elapse of predetermined time is for preventing the increase in the rotation speed due to thinning of the fuel concentration inside the cylinder 11. When the engine rotation speed exceeds a previously-set upper limit value (threshold), the procedure proceeds to Step 1211 so as to turn the solenoid valve 51 ON for predetermined time, so that additional fuel is injected so as to thicken the concentration inside the cylinder 11, and further increase in the engine rotation speed of the engine 10 is limited.

The procedure then proceeds to Step 1212, and the microcomputer 118 determines whether predetermined time has elapsed since the engine start or not. Here, if the previously-set predetermined time has not elapsed yet, the procedure returns to step 1210 to monitor the idling rotation speed. If the predetermined time has elapsed, the procedure proceeds to Step 1213. In Step 1213, an increase value of the engine rotation speed per unit time is monitored, and it is determined that the engine 10 is in the accelerating condition if this value exceeds a previously-set reference value. When it is judged that it is in the accelerating condition as described above, the procedure proceeds to Step 1215 to turn the solenoid valve 51 ON for predetermined time, so that additional fuel is injected so as to support a shortage in the fuel, and accelerating property of the engine 10 is improved.

When it is determined in Step 1213 that the previously-set reference value has not been exceeded yet, the procedure proceeds to Step 1214 to monitor the upper limit value of the engine rotation speed. When the engine rotation speed exceeds the previously-set upper value, the procedure proceeds to Step 1215 to turn the solenoid valve 51 ON for predetermined time, so that additional fuel is injected so as to thicken the concentration inside the cylinder 11, and further increase in the engine rotation speed of the engine is limited. This supply of additional fuel at this time is to suppress further increase in the rotation, and may not thicken the concentration as much as the engine rotation speed decreases. Next, the procedure proceeds to Step 1216 so that the microcomputer 118 determines whether predetermined time has elapsed since the activation or not. Here, if the previously-set predetermined time has not elapsed yet, the procedure returns to Step 1213 to monitor the engine rotation speed. If the predetermined time has elapsed, the FETs 117 and 132 are turned OFF (Step 1217). Since the FET 107 is also turned OFF by turning the FET 117 OFF, the power source of the control circuit 91 is once shut down.

Next, since the engine 10 continuously rotates, the engine rotation signal is continuously outputted from the rotation detecting coil 105. That is, power that is induced by the rotation detecting coil 105 is charged to the capacitor 129 via the diode 131 and the resistor 130 (Step 1218). The capacitor 129 is connected to a gate terminal of the FET 117 via the diode 127, and the FET 117 is again turned ON (Step 1219) when the predetermined time has elapsed so that the voltage of the capacitor 129 exceeds a gate ON voltage of the FET 117. Next, when the FET 107 is turned ON (Step 1220), the microcomputer 118 is again activated (Step 1221). The microcomputer 118 turns the FET 117 and 132 ON by supplying the gate signal so that the ON condition of the FET 107 is maintained (Step 1222). By turning the FET 132 ON, the voltage charged to the capacitor 129 is once discharged. The procedure then returns to Step 1213 to control the solenoid valve 51 in accordance with the condition of the engine 10.

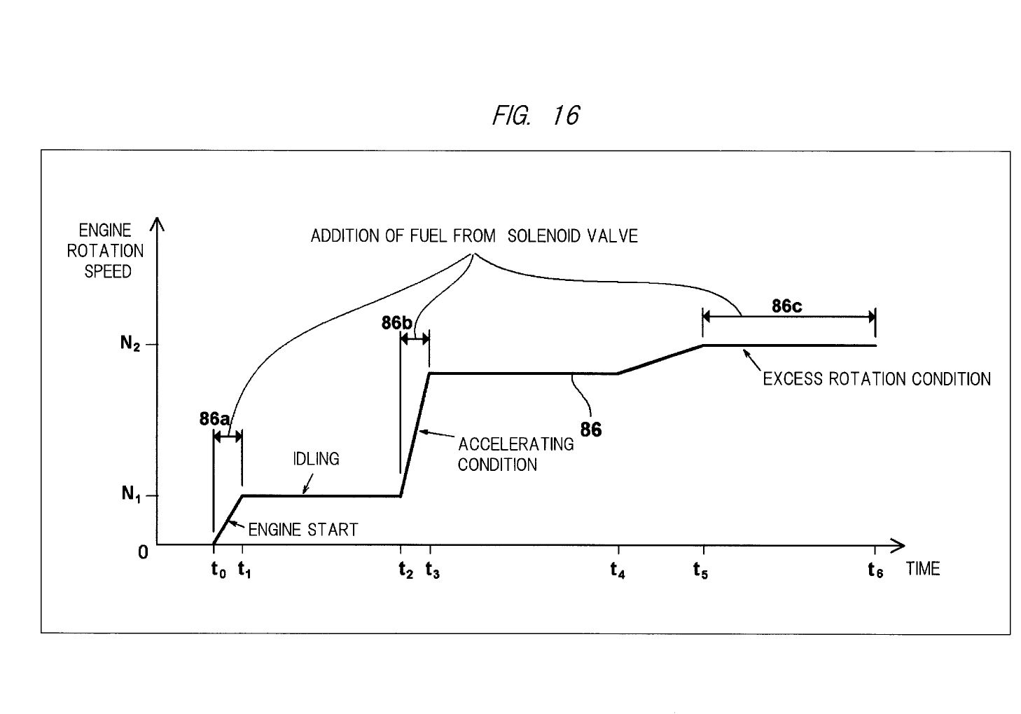

FIG. 16 is a graph for exemplifying the relation between time and engine rotation speed 86 in the series of operations. In FIG. 16, start-up of the engine 10 is started at time t₀, and the start-up is completed at time t₁ so that the engine 10 is in the idling rotating condition. When the operator operates a throttle lever 1007 at time t₂, the engine 10 starts to accelerate, and the acceleration of the engine 10 ends at time t₃. When the engine rotation speed of the engine 10 increases during the start-up time from time t₀ until t₁, and the additional fuel is supplied into an air-intake path using the solenoid valve 51 when the engine rotation speed comes close to a connection rotation speed (for example, 3,300 rpm) of a centrifugal clutch 29. In other words, the additional fuel supplying unit 50 is operated separately from supply of start-up fuel. In this manner, the increase in the engine rotation speed is suppressed so as to prevent sudden operation of the working tool due to sudden connection of the centrifugal clutch 29. The control of the solenoid valve 51 at this engine start-up is preferably performed during elapse of predetermined time from the engine start. In this control of the solenoid valve 51, fuel is additionally supplied by the solenoid valve 51 when the engine rotation speed is a predetermined threshold (for example, 3,000 rpm) or higher which is higher than the original idling rotation speed (for example, 2,800 rpm). Note that the connection rotation speed of the centrifugal clutch 29 is a rotation speed at which the swinging element 30a that is swung outwardly by centrifugal force is connected to the clutch drum 30b so that the clutch drum 30b starts to rotate. That is, the connection rotation speed of the centrifugal clutch 29 is an engine rotation speed at which the centrifugal clutch 29 is switched from a released condition to a connected condition.

During time from time t₂ to t₃, the control circuit 91 detects whether the engine 10 is in the accelerating condition or not, and it opens the solenoid valve 51 to supply the additional fuel when it is in the accelerating condition. In this manner, acceleration of the engine 10 is promoted. It is determined whether the engine 10 is in the accelerating condition or not by the control circuit 91 by periodically monitoring a variation value of the engine rotation speed per unit time. When the variation value of the engine rotation speed exceeds a previously-set threshold (predetermined value), the control circuit 91 determines that the engine 10 is in the accelerating condition so that the solenoid valve 51 is opened to additionally supply the fuel.

FIG. 16 illustrates a condition in which the engine rotation speed around the maximum output increases for some reasons at time t₄. FIG. 16 also illustrates a condition in which the engine rotation speed has reached the maximum allowable rotation speed N₂ (for example, 10,000 rpm) at time t₅. Note that the maximum allowable rotation speed N₂ is a rotation speed that is set to exceed the maximum output rotation speed (for example, 9,500 rpm). This maximum allowable rotation speed N₂ is set so that excessive rotation exceeding this speed is undesirable in view of duration of life or others. Therefore, in the present example, the microcomputer 118 opens the solenoid valve 51 to supply additional fuel when the engine 10 is in the excessive condition in which it exceeds the maximum output rotation speed. In this manner, the rotation speed of the engine 10 is controlled so as not to exceed the maximum allowable rotation speed N₂.

As described above, according to the present example, since the additional fuel supplying device 50 is provided separately from the carburetor 35, it is possible to supply fuel from the additional fuel supplying device 50 for the supplement, and thus to improve the startability of the engine 10. Since the engine rotation speed can be controlled by additionally supplying fuel from the additional fuel supplying device 50, it is possible to suppress the cost while achieving high functionality of the engine working machine 1. As illustrated in FIG. 16, in the engine start-up 86a, the solenoid valve 51 is controlled so that additional fuel (start-up fuel) is supplied into the air-intake path from the additional fuel supplying device 50. In an accelerating condition 86b and an excessive rotation condition 86c, the solenoid valve 51 is controlled so that the additional fuel is supplied into the air-intake path from the additional fuel supplying device 50. In this manner, it is possible to improve startability and acceleration property of the engine in a low temperature, and also to prevent the excessive rotation. Note that periods of operating the solenoid valve 51 in the re-spective conditions (t₀ to t₁, t₂ to t₃, and t₄ to t₅) may be appropriately set in accordance with engine properties, ambient temperature, and other conditions. A condition for setting the operating conditions of the solenoid valve 51 may be previously stored in the microcomputer 118.

In the foregoing, the present invention has been concretely described based on the example. However, it is needless to say that the present invention is not limited to the foregoing embodiment and various modifications and alterations can be made within the scope of the present invention. For example, the engine working machine has been explained as the brush cutter. However, not only the brush cutter but also other engine working machines such as a cutter, a chain saw, a lawn mower, and a cultivator may be adopted.

Hereinafter, each embodiment of the engine working machine and effects that can be obtained by each embodiment will be collectively described.

An engine working machine according to one embodiment is an engine working machine for driving a working tool using an engine including: a fuel tank; a carburetor for supplying an air-fuel mixture of air and fuel supplied from the fuel tank into a cylinder; a cylinder in which a piston is reciprocatable; and a crank case that holds the cylinder and that forms a crank chamber. The engine working machine is provided with an additional fuel supplying unit for supplying fuel to the engine separately from the carburetor, and a control unit for controlling an operation of the additional fuel supplying unit separately from supply of start-up fuel. In this manner, by the provision of the additional fuel supplying unit separately from the carburetor, it is possible to reduce costs of the engine working machine and to improve startability of the engine.

In an engine working machine according to another embodiment, the control unit supplies additional fuel from the additional fuel supplying unit in the start-up of the engine, and the control unit is provided with the maintenance mode for intermittently supplying additional fuel after a predetermined fuel supply by the additional fuel supplying unit. In this manner, the control unit determines whether the maintenance mode is required immediately after the start-up of the engine or not, and intermittently supplies the additional fuel after the predetermined fuel supply if the maintenance mode is required, so that it is possible to secure startability of the engine even when the carburetor is clogged. Even when it is difficult to maintain rotation of the engine immediately after the start-up of the engine due to the clogging of the carburetor, the fuel is continuously supplied from a fuel supplying route separately from the carburetor, and therefore, the rotation of the engine can be maintained. Further, by the rotation of the engine, clogging of the carburetor can be effectively eliminated by the negative pressure inside the cylinder. Note that the maintenance mode is executed during a predetermined period of time (period of time taken to reach duration, total engine rotation speed, and predetermined temperature) immediately after the start-up of the engine.

In an engine working machine according to another embodiment, the additional fuel supplying unit is provided at a flow path of fuel that is supplied from the fuel tank, and the additional fuel supplying unit has a solenoid valve for controlling fuel supply from the flow path to an air-intake path that extends from the carburetor into the cylinder. In this manner, it is possible to achieve a supply mechanism for additional fuel using a solenoid valve with a simple configuration.

In an engine working machine according to another embodiment, in the maintenance mode, the additional fuel supplying unit supplies additional fuel during “n” rotations (here, “m is larger than n”) of “m” rotations (here, “m is equal to or larger than 2”) of the engine. In this manner, in the maintenance mode, the minimum amount of fuel as much as the engine is not stopped can be supplied.

In an engine working machine according to another embodiment, in the maintenance mode, the additional fuel supplying unit supplies additional fuel for one rotation of “m” rotations (here, “m is equal to or larger than 2”) of the engine. In this manner, in the maintenance mode, the fuel flow rate after start-up of the engine can be set to an optimal value.

In an engine working machine according to another embodiment, in the maintenance mode, the additional fuel supplying unit supplies, to the air-intake path, additional fuel whose amount is less than that of the fuel supply used until the start-up of the engine. In this manner, it is possible to prevent misfire of the engine immediately after start-up.

An engine working machine according to another embodiment is provided with a switch for setting the maintenance mode, and the control unit shifts the condition to the control by the maintenance mode when the switch is turned ON. In this manner, it is possible to reliably execute operation in the maintenance mode with decision of the operator.

An engine working machine according to another embodiment is provided with a rotation-speed detecting unit for detecting the rotation speed of the engine, and the control unit determines whether to shift to the maintenance mode or not based on the engine rotation speed at the start-up of the engine or after the start-up. In this manner, the control unit determines whether to shift to the maintenance mode or not by detecting the engine rotation speed during the start-up control mode or after the start-up control mode. Accordingly, when the rotation speed of the engine decreases down to a predetermined rotation speed or lower after the start-up, it is possible to automatically supply fuel from the solenoid valve through a route different from the carburetor by the maintenance mode. In this manner, it is possible to automatically detect failure of the carburetor and to effectively eliminate the clogged condition of the carburetor.

An engine working machine according to another embodiment is provided with a timer unit for counting stop time of the engine, and the control unit measures the time during which the engine stops by using the timer unit, and shifts the condition to the maintenance mode when the stop time exceeds a predetermined value. In this manner, it is possible to largely improve the startability of the engine after the engine working machine is stored for a long time, and to eliminate clogging of the carburetor.

An engine working machine according to another embodiment is provided with a temperature detecting unit for detecting a temperature of the engine or of outside air, and with a rotation-speed detecting unit for detecting the rotation speed of the engine, and the control unit controls the amount of fuel to be added in accordance with the temperature detected by the temperature detecting unit, and fuel is supplied from the additional fuel supplying unit when the rotation speed of the engine decreases down to a predetermined rotation speed or lower after the start-up of the engine. In this manner, the control unit adjusts the amount of fuel to be added in the start-up in accordance with the detected temperature, and fuel is supplied from the additional fuel supplying unit when the rotation speed of the engine decreases down to a predetermined rotation speed or lower after start-up of the engine. Accordingly, it is possible to stably perform the start-up regardless of the outside air temperature or the engine temperature, and it is also possible to effectively prevent the engine stop immediately after the start-up.

An engine working machine according to another embodiment is provided with a rotation-speed detecting unit for detecting the rotation speed of the engine, and the control unit supplies additional fuel from the additional fuel supplying unit when the engine rotation speed that has been detected by the rotation-speed detecting unit exceeds a predetermined value. In this manner, it is possible to additionally supply fuel from the solenoid valve for thickening the concentration inside the cylinder even when the rotation (rotation speed or rotation-speed increasing rate) of the engine exceeds a predetermined value, so that the rotation of the engine can be controlled. In this manner, the additional fuel supplying unit can be functioned as an automatic choke function, and can be used also for the control of the rotation speed of the engine after the start-up.

In an engine working machine according to another embodiment, the additional fuel supplying unit is for supplying fuel to an air-intake path that extends from the carburetor to the cylinder, and has a solenoid valve, and the control unit controls opening and closing of the solenoid valve based on the rotation speed detected by the rotation-speed detecting unit. In this manner, it is possible to perform the control of the rotation speed of the engine using the different fuel supplying means from the carburetor. This solenoid valve is mainly for achieving the automatic choke function, and therefore, is for performing the rotation control in normal rotation using the automatic choke function from a different point of view.

In an engine working machine according to another embodiment, an insulator that forms the air-intake path is provided between the carburetor and the cylinder, and the additional fuel supplying unit is directly attached to the insulator or attached between the insulator and the carburetor via an attachment adaptor. In this manner, the present invention can be easily performed without changing the carburetor only by providing the attachment adaptor in a conventional engine working machine or by changing the insulator.

An engine working machine according to another embodiment is provided with a centrifugal clutch mechanism for connecting or interrupting transmission of output from the crank shaft of the engine to the working tool, and the control unit opens the solenoid valve so as to supply additional fuel when the rotation speed of the engine increases in the start-up of the engine to come close to the connection rotation speed of the centrifugal clutch mechanism. In this manner, it is possible to suppress the increase in the rotation speed due to thinning of fuel concentration immediately after start-up of the engine, and to prevent unexpected operations of the working tool such as unexpected rotation of a distal end blade due to clutch coupling.

In an engine working machine according to another embodiment, the control unit monitors the idling rotation speed during time taken from start-up of the engine until elapse of predetermined time, and additional fuel is supplied from the solenoid valve when the rotation speed of the engine is a predetermined threshold or higher. In this manner, it is possible to prevent unexpected coupling of the centrifugal clutch.

In an engine working machine according to another embodiment, the control unit opens the solenoid valve so as to supply additional fuel when the engine is in an excess rotation condition so as to exceed the maximum output rotation speed. In this manner, it is possible to reliably prevent further increase in the rotation from the excess rotation condition, to achieve improvement in fuel efficiency and suppression in oscillation and noise, and also to prevent shortening of the life of the engine.

In an engine working machine according to another embodiment, the control unit detects whether the engine is in an accelerating condition or not, and opens the solenoid valve when it is in the accelerating condition so as to supply additional fuel and thus to promote acceleration. In this manner, it is possible to eliminate shortage of fuel in the acceleration and to improve acceleration of the engine.

In an engine working machine according to another embodiment, the control unit additionally supplies fuel from the solenoid valve when a variation value of the rotation speed per unit time detected by the rotation-speed detecting unit exceeds a previously-set predetermined value. In this manner, it is possible to reliably detect whether the engine is in the accelerating condition or not, and to improve acceleration.

An engine working machine according to another embodiment has a rotation detecting coil in which power is generated by the rotation of the engine, and a storage unit for storing power that is generated by the rotation detecting coil, and the control unit is periodically activated by the power of the storage unit, and the control unit interrupts its own power source upon elapse of predetermined time after the activation. In this manner, it is possible to suppress battery consumption.

### REFERENCE SIGNS LIST

1 engine working machine
10 engine
11 cylinder
12 piston
13 crank shaft
14 crank case
15 fixing adaptor
15a air-intake path
15b screw hole
15c pulse hole
15d attachment hole
15e screw hole
16 muffler
17 bolt
18 wire
19 insulator
20 and 21 screw
22 magneto-rotor
23 ignition coil
24 ignition cord
25 ignition plug
25a plug cap
26 air cleaner box
27 fuel tank
27b and 27c through hole
29 centrifugal clutch
30a swinging element
30b clutch drum
31 decompression
32 clutch shaft
33 bearing
34 housing
35 carburetor
36 choke lever
37 priming pump
39 battery housing unit
39a opening portion
40 recoil starter
41 reel
42 starter rope
43 spiral spring
46 one-way clutch
47 second drum
48 bearing
49 gear
50 additional fuel supplying device
51 solenoid valve
51a main body unit
51b fixing fitting
52 movable piece
53 lead wire
54 plunger
54a distal end portion
56 solenoid-valve fixing unit
56a space
56b protruding portion
57 fuel chamber
57a cylindrical space
57b protruding portion
57c fuel chamber
58 plunger abutting unit
59a and 59b ring
60 fuel path
60a fuel inlet path
60b fuel outlet path
61 bolt
71 fuel pipe
72 filter
73 fuel pipe
74 return pipe
76a rubber bush
77 pinion
78 one-way clutch
79 first drum
80 battery
81 release button
81a hook unit
83 terminal
84 terminal
90 control circuit board
91 engine-rotation pulse signal
92 solenoid-valve driving signal
96 engine-rotation pulse signal
97 solenoid-valve driving signal
97a arrow
102 connection line
105 rotation detecting coil
106 cell motor
106a rotation shaft
107, 117, 121, 122, and 132 FET
108, 109, 111, 112, 120, 124, and 127 resistor
110 power source switch
113, 114, and 115 capacitor
116 regulator
118 microcomputer
119 thermistor
125 starter switch
128 mode switch
501 engine working machine
1001 engine working machine
1004 main pipe
1007 throttle lever
108 engine
1009 grip unit
1010 engine
1012 rotary blade
1013 scatter protection cover
1045 wire

1-19. (canceled)

20. An engine working machine for driving a working tool by using an engine,
wherein the engine includes:
a fuel tank;
a carburetor for supplying air-fuel mixture of fuel supplied from the fuel tank and air into a cylinder;
a cylinder in which a piston is reciprocatable; and
a crank case that holds the cylinder and forms a crank chamber, and
wherein the engine working machine includes:
an additional fuel supplying unit for supplying fuel to the engine, and
a control unit for controlling an operation of the additional fuel supplying unit separately from supply of start-up fuel.

21. The engine working machine according to claim 20,
wherein the control unit supplies additional fuel from the additional fuel supplying unit in start-up of the engine, and
the control unit is provided with a maintenance mode for intermittently supplying additional fuel after predetermined fuel supply from the additional fuel supplying unit.

22. The engine working machine according to claim 21,
wherein the additional fuel supplying unit is provided at a flow path of fuel that is supplied from the fuel tank, and
the additional fuel supplying unit has a solenoid valve for controlling fuel supply from the flow path to an air-intake path that extends from the carburetor into the cylinder.

23. The engine working machine according to claim 21,
wherein, in the maintenance mode, the additional fuel supplying unit supplies additional fuel during n rotations (here, m is larger than n) of m rotations (here, m is equal to or larger than 2) of the engine.

24. The engine working machine according to claim 21,
wherein, in the maintenance mode, the additional fuel supplying unit supplies additional fuel during one rotation of m rotations (here, m is equal to or larger than 2) of the engine.

25. The engine working machine according to claim 22,
wherein, in the maintenance mode, to the air-intake path, the additional fuel supplying unit supplies additional fuel whose amount is less than an amount of the fuel supply used until the start-up of the engine.

26. The engine working machine according to claim 21,
wherein the engine working machine is provided with a switch for setting the maintenance mode, and
the control unit shifts a condition to control by the maintenance mode when the switch is turned ON.

27. The engine working machine according to claim 21,
wherein the engine working machine is provided with a rotation-speed detecting unit for detecting a rotation speed of the engine, and
the control unit determines whether to shift to the maintenance mode or not based on the rotation speed of the engine in the start-up of the engine or after the start-up.

28. The engine working machine according to claim 21,
wherein the engine working machine is provided with a timer unit for counting stop time of the engine, and
the control unit measures the time during which the engine stops by using the timer unit, and shifts a condition to the maintenance mode when the stop time exceeds a predetermined value.

29. The engine working machine according to claim 21,
wherein the engine working machine is provided with: a temperature detecting unit for detecting a temperature of the engine or of outside air; and a rotation-speed detecting unit for detecting a rotation speed of the engine, and
the control unit controls an amount of additional fuel in accordance with the temperature detected by the temperature detecting unit, and supplies the fuel from the additional fuel supplying unit when the rotation speed of the engine decreases down to a predetermined rotation speed or lower after the start-up of the engine.

30. The engine working machine according to claim 20,
wherein the engine working machine is provided with a rotation-speed detecting unit for detecting the rotation speed of the engine, and
the control unit supplies additional fuel from the additional fuel supplying unit when the rotation speed of the engine detected by the rotation-speed detecting unit exceeds a predetermined value.

31. The engine working machine according to claim 30,
wherein the additional fuel supplying unit is for supplying fuel to an air-intake path that extends from the carburetor to the cylinder and has a solenoid valve, and
the control unit controls opening and closing of the solenoid valve based on the rotation speed detected by the rotation-speed detecting unit.

32. The engine working machine according to claim 30,
wherein an insulator that forms an air-intake path is provided between the carburetor and the cylinder, and
the additional fuel supplying unit is directly attached to the insulator or attached between the insulator and the carburetor via an attachment adaptor.

33. The engine working machine according to claim 31,
wherein the engine working machine is provided with a centrifugal clutch mechanism for connecting or interrupting transmission of output from a crank shaft of the engine to the working tool, and
the control unit opens the solenoid valve so as to supply additional fuel when the rotation speed of the engine increases in the start-up of the engine to come close to a connection rotation speed of the centrifugal clutch mechanism.

34. The engine working machine according to claim 31,
wherein the control unit monitors an idling rotation speed taken from the start-up of the engine until elapse of predetermined time, and supplies additional fuel from the solenoid valve when the rotation speed of the engine is a predetermined threshold or lower.

35. The engine working machine according to claim 31,
wherein the control unit opens the solenoid valve so as to supply additional fuel when the engine is in an excess rotation condition so as to exceed the maximum output engine rotation speed.

36. The engine working machine according to claim 31,
wherein the control unit detects whether the engine is in an accelerating condition or not, and opens the solenoid valve so as to supply additional fuel and thus to promote acceleration when it is in the accelerating condition.

37. The engine working machine according to claim 31,
wherein the control unit supplies additional fuel from the solenoid valve when a variation value of the rotation speed per unit time detected by the rotation-speed detecting unit exceeds a previously-set predetermined value.

38. The engine working machine according to claim 30,
wherein the engine working machine has: a rotation detecting coil in which power is generated by rotation of the engine; and
a storage unit for storing the power generated in the rotation detecting coil, and the control unit is periodically activated by the power of the storage unit, and the control unit interrupts its own power source when predetermined time elapses after the activation.
